(19) United States
(12) Patent Application Publication
(10) Pub. No.: US 2025/0247294 A1
(43) Pub. Date: Jul. 31, 2025

(54) SYSTEM AND METHOD FOR DETERMINING CONFIGURATIONS FOR A PLURALITY OF PERIPHERAL DEVICES BASED ON PRIOR EXPERIENTIAL COMPLIANCE OR LEAST COMMON DEVICE FUNCTIONALITY COMPLIANCE

(71) Applicant: Dell Products, LP, Round Rock, TX (US)

(72) Inventors: Anantha K. Boyapalle, Cedar Park, TX (US); Srinivasa Ragavan Rajagopalan, Bangalore (IN); Vivekanandh Narayanasamy Rajagopalan, Bangalore (IN); Ramanujam K. Venkatesh, Bangalore (IN)

(73) Assignee: Dell Products, LP, Round Rock, TX (US)

(21) Appl. No.: 18/429,071

(22) Filed: Jan. 31, 2024

(51) Int. Cl. H04L 41/084; H04L 41/0806

(52) U.S. Cl. CPC H04L 41/0846; H04L 41/0806

(57) ABSTRACT

A peripheral device workspace cloud orchestrator executing at a cloud information handling system may comprise a network interface device to receive a user experience fingerprint associated with a user of an information handling system that has been previously operatively coupled to a previous peripheral device at a first location of a previous peripheral device workspace having operational configurations of previous peripheral device functional capabilities controlling operation of the previous peripheral device, and a hardware processor to determine for a new peripheral device node functional capabilities in a new peripheral device workspace operatively coupled to the user information handling system at a second identified location based on a user experiential compliance value to determine whether to apply operational configurations of previous peripheral device functional capabilities to the new peripheral device node and the hardware processor to execute code instructions to configure the new peripheral device node according to those operational configurations.

### FIELD OF THE DISCLOSURE

The present disclosure generally relates to automatic assessment or configuration of peripheral devices for use in shared peripheral device workspaces or collaborative peripheral device workspaces. The present disclosure more specifically relates to assessment or automated setup and updating of configurations for a shared peripheral device shared among occupants of a shared space such as a hoteling office or for a collaborative peripheral device of a peripheral device workspace in use by a plurality of users simultaneously, based on functionality and configurations for each of the information handling system anchor nodes for the peripheral device workspace that are operatively coupled to the shared peripheral device or the collaborative peripheral device within the peripheral device workspace.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, video communication capabilities, and audio capabilities. The information handling system may be operatively coupled to one or more wireless peripheral input/output devices such as a keyboard, mouse, touchpad, gaming controller, display device, wearable peripheral device, speakers, earbud, headphone, microphone, stylus, or other peripheral devices.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating a cloud-based information handling system executing code instructions of a peripheral device workspace cloud orchestrator to orchestrate configuration of peripheral devices across a plurality of user peripheral device workspaces according to an embodiment of the present disclosure;

FIG. 2 is a block diagram illustrating a cloud-based peripheral device workspace cloud orchestrator for defining a plurality of peripheral device workspaces each including a user information handling system and peripheral devices according to an embodiment of the present disclosure;

FIG. 3A is a block diagram illustrating a new peripheral device in a new peripheral device workspace interfacing with a peripheral device workspace cloud orchestrator server to be automatically configured using default or previously user-selected adjustable operational configurations for nodes from the user's previous matching peripheral device workspace according to an embodiment of the present disclosure;

FIG. 3B is a block diagram illustrating a collaborative peripheral device workspace interfacing with a peripheral device workspace cloud orchestrator server to be automatically configured to accommodate the capabilities of each of a plurality of operatively coupled information handling systems for a collaborative peripheral device node according to an embodiment of the present disclosure;

FIG. 4 is a flow diagram illustrating a method of automatically configuring peripheral devices within a new peripheral device workspace to meet peripheral device settings and configurations from a user's previously-used peripheral device workspace and experience identifier according to an embodiment of the present disclosure; and

FIG. 5 is a flow diagram illustrating a method of automatically configuring a collaborative peripheral device in a collaborative peripheral device workspace according to peripheral device operational capabilities that each of the operatively coupled user information handling systems can accommodate according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

A user may oftentimes use an information handling system in a peripheral device workspace. In this context, a peripheral device workspace can be viewed as an environment that includes a user information handling system (e.g., a laptop) operating as an anchor node for the peripheral device workspace and peripheral devices operating as secondary nodes of the peripheral device workspace that are connected to the user information handling system. An environmental context may include, for example, location, time of day, applications being executed, wireless or wired connection capabilities, or security credentials for the user. Peripheral devices may commonly include internal or external devices such as displays, a keyboard, a mouse, a webcam, a printer, a speaker, a fingerprint scanner, etc. In various embodiments, a peripheral device workspace may include a wired or wireless dock by which the user information handling system connects to some or all the peripheral devices including smart peripheral devices having some compute or input/output capabilities.

A peripheral device workspace, in various embodiments, be used for hybrid work scenarios. For example, a business may have an office space that includes hoteling cubes that can be assigned to, reserved by, or otherwise utilized by the business's employees as peripheral device workspaces. In such cases, the business may allow its employees to connect their laptops to a dock in a particular hoteling cube where various peripherals may be available for use. In other embodiments, a business may have collaborative peripheral device workspace such as for a conference room or a meeting room. Users may also employ peripheral device workspaces when working from home or other locations.

When a user employs multiple peripheral device workspaces (e.g., by connecting a laptop to different combinations of peripheral devices during a workday), it can be tedious for the user to configure the peripheral device workspaces to his or her preferences. For example, while using one peripheral device workspace, the user may set configurations for the peripheral devices of the peripheral device workspace to match the user's preferences. If the user switches to a different peripheral device workspace, those configurations may not be consistent with the peripheral devices of the different peripheral device workspace or may result in unintended changes. The user may therefore have to manually reconfigure the peripheral devices within the peripheral device workspace.

As one particular example, a user may have a home peripheral device workspace that includes a 4K monitor peripheral device with 3840×2160 resolution at 60 Hz that is in landscape orientation and that also includes a 32-inch Full High Definition (FHD) monitor with 1920×1080 resolution that is in portrait orientation. This user may have set adjustable operational configurations for this home peripheral device workspace to personalize these display devices. The user may also have access to multiple office peripheral device workspaces (e.g., in a hoteling scenario), and these peripheral device workspaces may have different sets of peripheral devices such as a first office peripheral device workspace with two display devices and a second office peripheral device workspace with a single display device or a conference room. If the user's adjustable operational configurations for the home peripheral device workspace are applied to the office peripheral device workspaces, the display device(s) will likely not be configured in accordance with the user's preferences. The user will then need to manually reconfigure the office peripheral device workspace to achieve her preferences. When the user returns to her home peripheral device workspace, she may again be required to manually reconfigure the home peripheral device workspace. As can be seen, when using multiple peripheral device workspaces, personalized adjustable operational configurations for peripheral devices are likely to be lost or misapplied due to the mismatching set of peripheral devices that make up the peripheral device workspaces. These issues arise in cases where the user switches between entirely different peripheral device workspaces (e.g., when leaving home where a home peripheral device workspace is used to travel to work where an office peripheral device workspace is used) as well as in cases where the user alters a peripheral device workspace through the connection and/or disconnection of a peripheral device (e.g., when connecting an external webcam to a dock or laptop that is part of an existing peripheral device workspace).

Execution of code instructions for an ecosystem manageability sub-agent on a user information handling system monitor for context of a peripheral device workspace, such as time, location, applications currently executing or planned, connection type (e.g., wireless, wired, wireless wide area network (WWAN), wireless local area network (WLAN), wireless private area network (WPAN)), security credentials for the user, or environmental sensor readings (e.g., humidity, temperature), among other possible telemetry readings for the information handling system. These telemetry measurements may be gathered routinely, or upon each startup of an information handling system, for example. Further, the ecosystem manageability sub-agent executing at the information handling system may create a manifest of peripheral devices at a location to represent the current peripheral device workspace, including an identification of the user, an identification (e.g., by Media Access Control (MAC) address) of each of the peripheral devices connected to or operably coupled to the information handling system, one or more context features (e.g., time, location, applications executing, etc.), and one or more adjustable operational configurations (e.g., resolution for an external display device) for the operably coupled peripheral devices. Peripheral device workspaces may be associated with a peripheral device workspace identification value and include a location identifier and a manifest of peripheral devices or other nodes, such as anchor node information handling system or systems or smart nodes which is stored in a peripheral device workspace cloud orchestrator server database, peripheral device workspace management system database, or similar cloud based database in embodiments herein. Such a manifest may be written in a machine-readable language or machine markup language such as JavaScript Object Notation (JSON), for example, and transmitted for storage at the peripheral device workspace management system database associated with a peripheral device workspace cloud orchestrator operating in a cloud computing platform. The peripheral device workspace identification value for a peripheral device workspace may also have associated with it additional information such as the telemetry information described above or contextual data about the operational capabilities and settings of nodes, including peripheral device nodes, smart peripheral device nodes, and anchor information handling system nodes in particular peripheral device workspaces. Each time a peripheral device adjustable operational configuration is changed by the user, a new peripheral device is added to the peripheral device workspace, or a new context is detected, an updated or new peripheral device workspace anchor node status update document including this updated adjustable operational configuration, context information, or new peripheral device registration may be transmitted to a peripheral device workspace cloud orchestrator executing at a cloud platform for the peripheral device workspace identification value.

Various peripheral device workspaces such as the hybrid work office peripheral device workspaces, collaborative peripheral device workspaces, and other peripheral device workspaces described herein may be defined by location indicator detected for an anchor node information handling system operating at the peripheral device workspace as well as a manifest of nodes of peripheral devices and smart devices that may operate in the peripheral device workspace. As described, each such defined peripheral device workspace may also be assigned a peripheral device workspace identification value which may be stored and associated with stored manifests of nodes operating in the peripheral device workspace at the peripheral device management system database, peripheral device workspace cloud orchestrator server database, or similar remote database. Additional environmental context data for the peripheral device workspace may be stored within one or more peripheral device workspace anchor node status update documents as well as included in the definition of the peripheral device workspace and associated with its peripheral device workspace identification value defined at the peripheral device workspace cloud orchestrator server database, including peripheral device capabilities, peripheral device connectivity details, current peripheral device configurations or settings, peripheral device setting or configuration options, current status of the peripheral devices within the peripheral device workspace, and other features of nodes within the peripheral device workspace. For example, the definition of the peripheral device workspace associated with a specific peripheral device workspace identification value may include a set of environmental context data and stored within one or more peripheral device workspace anchor node status update documents, such as time, applications currently executing or planned, connection type, hardware component capabilities or usage metrics, or environmental sensor readings (e.g., humidity, temperature), among other possible environmental context telemetry readings for an anchor node information handling system operating within the defined peripheral device workspace.

A peripheral device workspace may be defined by a location identifier (e.g., location in a wireless or wired network, global positioning, or other having an association with a physical location), a list of peripheral devices operatively coupled to an anchor node information handling system for a user, type of peripheral device workspace (e.g., personal, hoteling office/shared, or collaborative), and additionally in some cases, by one or more of the types of environmental context data for the peripheral device workspace described herein. Each of these defining factors may be associated in memory for the peripheral device workspace management system with the peripheral device workspace identification value, which may also be associated with one or more peripheral device operational configuration policies describing how the peripheral device nodes within the defined peripheral device workspace are to operate. Thus, a particular peripheral device operational configuration policy for one or more peripheral devices within a given peripheral device workspace having a peripheral device workspace identification value may apply only when certain environmental context telemetries of one or more of the types of environmental context data, such as telemetries describing usage patterns for those peripheral devices are detected. In such a way, the peripheral device operational configuration policy for a peripheral device within a peripheral device workspace may be defined or associated with particularly defined usage patterns for that peripheral device. For example, a peripheral device operational configuration policy may apply only when certain software applications are executing at the anchor node information handling system defined within the peripheral device workspace, or when one or more hardware components' (e.g., graphics processing unit (GPU), central processing unit (CPU), memory) usage metrics or connectivity metrics meet a predefined threshold.

A database memory for the peripheral device workspace management system may further store a user composite peripheral device workspace identifier that is unique to individual users of one or more defined peripheral device workspaces that are associated with identification of the user of the user's information handling system and peripheral device workspace identification values of the peripheral device workspaces used by that user. Thus, a user composite peripheral device workspace identifier may identify a single user of an anchor node information handling system, and a peripheral device workspace identification value for each of one or more peripheral device workspaces in which the user's information handling system operates as an anchor node at various times. The user composite peripheral device workspace identifier may thus be user-specific and user-centric. The peripheral device workspace identification value, in comparison, may define a location and list of peripheral device nodes, and may thus be peripheral device workspace-centric.

Each user composite peripheral device workspace identifier may be associated with a single user, and may further include one or more user experience fingerprints with a user experience identifier (xID) defining usage patterns or the ways in which the single user uses the anchor node information handling system and one or more peripheral devices within defined peripheral device workspaces in which the single user operates. A user experience fingerprint having an xID may include a list of peripheral device nodes within a defined peripheral device workspace associated with a peripheral device workspace identification value and the user's composite peripheral device workspace identifier, as well as capabilities for each of those listed peripheral devices, and at least one peripheral device operational and environmental context telemetry readings of the peripheral device workspace describing a pattern of usage for the specific user of the anchor node information handling system. The user experience fingerprint may be used to link usage patterns for the anchor node information handling system (e.g., execution of specific software applications or high usage rates for various hardware components at the anchor node) with the capabilities and settings for the operatively coupled peripheral devices within the peripheral device workspace.

As described herein, when users shift from a personalized peripheral device workspace to a shared peripheral device workspace such as a hoteling office or a collaborative peripheral device workspace such as a meeting conference room, there is often a mismatch between the capabilities for the peripheral devices within the shared or collaborative peripheral device workspace and the capabilities or configurations for the peripheral devices within the users' personalized peripheral device workspaces. A cloud-based server executing code instructions of the compliance-adjusted automatic node configuration module in embodiments herein may leverage the user experience fingerprints for each of such users, as described directly above, to more accurately match the capabilities and configurations of the peripheral devices within the shared peripheral device workspace or the collaborative peripheral device workspace with the capabilities and configurations of the peripheral devices within the users' personalized peripheral device workspaces. In such a way, the shared peripheral devices or the collaborative peripheral devices within the shared peripheral device workspace or the collaborative peripheral device workspace may be configured to most closely match the users' desired experiences and workload needs, as defined within one or more of each users' xID.

In order to configure a peripheral device within a shared peripheral device workspace or a collaborative peripheral device workspace to most closely match each user's desired experiences, code instructions of the compliance-adjusted automatic node configuration module may be executed to identify a peripheral device operational configuration policy confirmed to meet the user's desired experience for a peripheral device within a user's previously established personalized peripheral device workspace that may be applied to the same type of peripheral device within the shared peripheral device workspace or collaborative peripheral device workspace that the user has just joined. However, this may only be possible if the capabilities of the peripheral device within the user's previously established personalized peripheral device workspace correspond to or match the capabilities of the peripheral device within the shared peripheral device workspace or the collaborative peripheral device workspace. In embodiments, code instructions of the compliance-adjusted automatic node configuration module may be executed to determine a user experiential compliance value that compares the capabilities and configurations of the peripheral devices within the shared peripheral device workspace or the collaborative peripheral device workspace the user has recently joined with the capabilities and configurations of the peripheral devices within the users' personalized peripheral device workspaces.

For example, upon the user information handling system anchor node powering up at the shared peripheral device workspace location or the collaborative peripheral device workspace location, the anchor node information handling system may generate or gather and transmit to the collaborative workspace consistent user experience maintenance system the manifest of peripheral devices within the shared peripheral device workspace or the collaborative peripheral device workspace, an identification of the user of the user's information handling system anchor node, and peripheral device workspace environmental context data including capabilities of the peripheral devices within the shared peripheral device workspace or the collaborative peripheral device workspace, as described above with respect to a peripheral device workspace anchor node status update document. Code instructions of the compliance-adjusted automatic node configuration module may then execute to identify the user composite peripheral device workspace identifier associated with that user, and any user xIDs and peripheral device workspace identification values associated with that user composite peripheral device workspace identifier. As described herein, any user xIDs identified in such a way may further be associated with a user experience fingerprint list of capabilities of peripheral devices within that user's personalized peripheral device workspaces.

Code instructions for the compliance-adjusted automatic node configuration module may then be executed to retrieve one or more peripheral device operational configuration policies associated with or defining the peripheral device workspace having the peripheral device workspace identification value associated with the user composite peripheral device workspace identifier for that user. As described above, the peripheral device workspace identification value may be associated with one or more peripheral device operational configuration policies describing how the peripheral device nodes within the defined peripheral device workspace are to operate. In some cases, a particular peripheral device operational configuration policy for one or more peripheral devices within a given peripheral device workspace having a peripheral device workspace identification value may apply only when certain peripheral device environmental context telemetries, such as telemetries describing usage patterns for those peripheral devices are detected. In some embodiments, code instructions of the compliance-adjusted automatic node configuration module may execute to first determine whether the received peripheral device workspace anchor node status update document identifies such a peripheral device environmental context telemetries. In such embodiments, the code instructions for the compliance-adjusted automatic node configuration module may then execute a second step to retrieve one or more peripheral device operational configuration policies associated with the identified peripheral device environmental context telemetries for configurations and settings of nodes during operation. If the peripheral device operational configuration policies associated with the peripheral device workspace identification value for the user's personalized peripheral device workspaces are not associated with a specific peripheral device environmental context telemetry, the compliance-adjusted automatic node configuration module may retrieve the peripheral device operational configuration policies associated generally with the peripheral device workspace identification value for the user's personalized peripheral device workspace(s).

Code instructions for the compliance-adjusted automatic node configuration module may then execute to determine a user experiential compliance value that compares the capabilities the peripheral devices within the shared peripheral device workspace or the collaborative peripheral device workspace, as given within the peripheral device workspace environmental context data of the peripheral device workspace anchor node status update document with capabilities and configurations of the peripheral devices within the users' personalized peripheral device workspaces, as given within the retrieved peripheral device operational configuration policies. A peripheral device operational configuration policy for any one of the peripheral devices within the user's already established personalized peripheral device workspace may be recommended for application to peripheral devices within the shared peripheral device workspace or the collaborative peripheral device workspace when the user experiential compliance value meets a minimum threshold value, indicating a close match between the capabilities of the peripheral devices within the collaborative peripheral device workspace and the peripheral devices within the user's previously established personalized peripheral device workspace. In other embodiments, when such a user experiential compliance value meets a minimum threshold value, already established personalized peripheral device workspace may be automatically applied. The determination of the user experiential compliance value in embodiments may be repeated for each retrieved or identified peripheral device operational configuration policy in embodiments. In the case where the user experiential compliance value for a given peripheral device operational configuration policy meets such a threshold value, code instructions for the compliance-adjusted automatic node configuration module may execute to recommend or automatically perform configuration of a peripheral device within the collaborative peripheral device workspace according to the retrieved peripheral device operational configuration policy. In such a way, the shared or collaborative peripheral devices within the share peripheral device workspace may be configured to most closely match the users' desired experiences and workload needs, as defined within one or more of each users' xID values associated with a user composite peripheral device workspace identifier for the user.

In the case where multiple users are simultaneously sharing or are operatively coupled to the same collaboration peripheral device, such as a conference room projector, in a collaborative peripheral device workspace, it may be desirable to configure the collaboration peripheral device in a way that each of the operatively coupled users may interact with it in a similar fashion. For example, a conference room projector may be capable of display according to a plurality of resolutions, including a 3840×2160 pixel 4K ultra high definition (4K UHD) resolution. However, not all users operatively coupled to the conference room projector at a given time may be capable of output from their information handling systems to the conference room projector in 4K UHD resolution. One of the plurality of information handling systems may be capable of output having a highest possible resolution of sub-high definition 1920×1080 pixels. In such a case, it may be desirable to configure the collaboration peripheral device (e.g., conference room projector) to display at the 1920×1080 pixel resolution at which all of the users' information handling systems currently operatively coupled to the collaboration peripheral device are compatible within the collaborative peripheral device workspace.

For example, upon the plurality of user information handling systems anchor powering up at the collaboration peripheral device workspace location that includes the conference room projector, one or more of the information handling systems may generate or gather and transmit to the compliance-adjusted automatic node configuration module the manifest of peripheral devices within the shared or collaborative peripheral device workspace (including the conference room projector), an identification of each of the users of those information handling systems, and peripheral device workspace environmental context data including capabilities of the peripheral devices within the collaborative peripheral device workspace, as described above with respect to a peripheral device workspace anchor node status update document. Execution of code instructions for the compliance-adjusted automatic node configuration module may determine that a plurality of user information handling systems have operatively coupled to a collaborative peripheral device to form a collaborative peripheral device workspace, based on this received information. Upon making such a determination, the code instructions for the compliance-adjusted automatic node configuration module may execute to identify, for each of the collaborating user information handling systems that have joined the collaborative peripheral device workspace, capabilities of each of the collaborating users' information handling systems, as given within the received peripheral device workspace anchor node status update document.

In order to provide the same user experience to each of the user information handling systems within the detected collaborative peripheral device workspace, code instructions for the compliance-adjusted automatic node configuration module may execute to configure the collaborative peripheral device, such as the conference room projector for use by all coupled users' information handling systems simultaneously. In some embodiments, configurations and settings for the collaborative peripheral devices may be determined for plural users according to xIDs for those plural users from their user composite peripheral device workspace identifier data. This may involve, for example, determining one or more configurations for the collaborative peripheral device with which the capabilities of each of the user information handling systems within the collaborative peripheral device workspace are compatible. In other words, code instructions of the compliance-adjusted automatic node configuration module may execute to identify one configuration or setting for the collaborative peripheral device that each of the collaborating user information handling systems can accommodate. For example, code instructions of the compliance-adjusted automatic node configuration module may execute to identify a screen resolution for a collaborative conference room projector that each of the collaborating user anchor information handling system nodes are capable of supporting, or for which they may each be configured. Further, each user may have configuration preferences as well as capabilities as determined from xIDs for previous uses of such a collaborative peripheral device node in other peripheral device workspaces.

The compliance-adjusted automatic node configuration module may then execute code instructions to generate a peripheral device operational configuration policy for the collaboration peripheral device and each of the operatively coupled collaborating user information handling systems for users within the collaborative peripheral device workspace reflecting the determined configuration or setting for the collaborative peripheral device that each of the collaborating user information handling systems can accommodate or is determined to be a desired configuration from xID data of previous usages. The compliance-adjusted automatic node configuration module may execute code instructions to then transmit that peripheral device operational configuration policy to the ecosystem manageability sub-agent at each of the collaborating user information handling systems and the collaborative peripheral device for application at each of these devices, as described above. In such a way, execution of code instructions of the compliance-adjusted automatic node configuration module may automatically configure collaborative peripheral devices such as conference room projectors for use by all collaborating and operatively coupled user information handling systems.

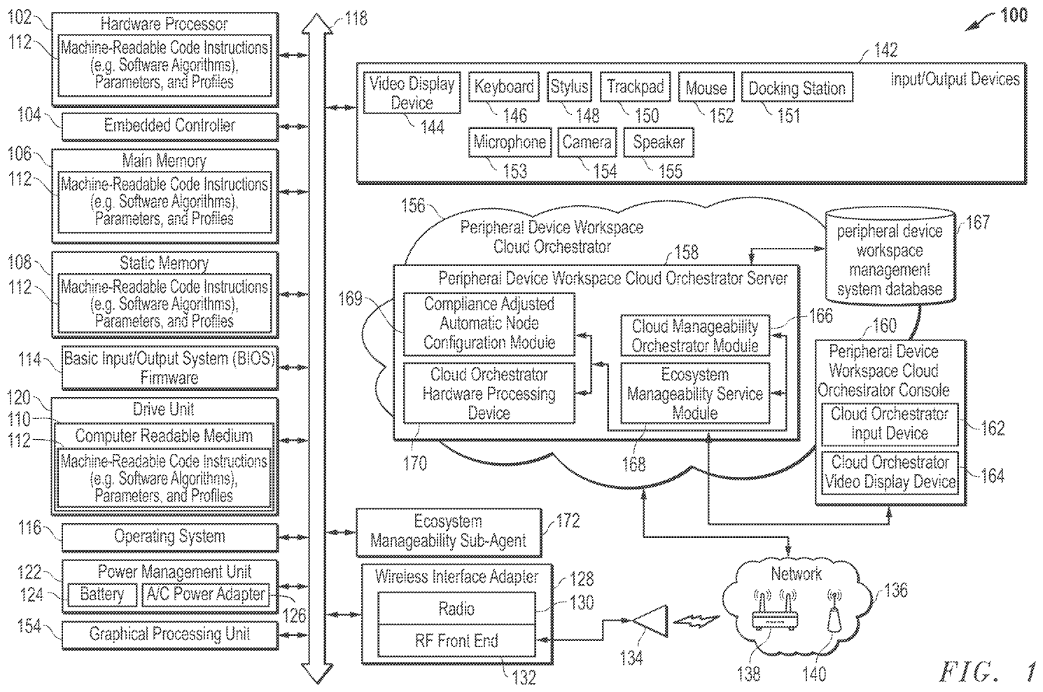

FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 138, a base station transceiver 140, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality. It is appreciated that, in some embodiments herein, the information handling system 100 may be one of a plurality of device nodes as part of a peripheral device workspace described in embodiments herein or an information handling system 100 may serve as a peripheral device workspace cloud orchestrator server 158 that is operatively coupled to a peripheral device workspace cloud orchestrator console 160 in the peripheral device workspace cloud orchestrator 156 described herein. In an embodiment, the cloud orchestrator console 160 may also be graphical user interface operating on an information handling system 100 itself that is used by an internet technology decision maker (ITDM) to create peripheral device operational configuration policies with one or more peripheral device workspace cloud orchestrator servers 158 to be propagated down to node devices within a peripheral device workspace such as the information handling system 100, a docking station 151, video display device 144, keyboard 146, stylus 148, microphone 153, camera 154, speaker 155, trackpad 150, mouse 152, and the like. In this embodiment, the information handling system 100, may receive the peripheral device operational configuration policies generated by the ITDM at the peripheral device workspace cloud orchestrator console 160, or generated by the peripheral device workspace cloud manageability orchestrator module 166 based on default peripheral device configuration settings via execution of code instructions of the cloud manageability orchestrator module 166 and the ecosystem manageability service module 168 at the peripheral device workspace cloud orchestrator server 158 as described in embodiments herein.

Thus, in a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 106, (volatile (e.g., random-access memory, etc.), or static memory 108, nonvolatile (read-only memory, flash memory etc.) or any combination thereof), one or more hardware processing resources, such as a hardware processor 102 that may be a central processing unit (CPU), a graphics processing unit (GPU) 103, embedded controller (EC) 104, or any combination thereof. Additional components of the information handling system 100 may include one or more storage devices such as static memory 108 or drive unit 120. The information handling system 100 may include or interface with one or more communications ports for communicating with external devices, as well as various input and output (I/O) devices 142, such as a docking station 151, a mouse 152, a trackpad 150, a keyboard 146, a stylus 148, a video/graphics display device 144, a microphone 153, a camera 154 such as a webcam, an external speaker or headset 155, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 112 that may operate on servers or systems, remote data centers, or on-box in individual client information handling systems according to various embodiments herein. In some embodiments, it is understood any or all portions of instructions (e.g., software algorithms), parameters, and profiles 112 may operate on a plurality of information handling systems 100.

The information handling system 100 may include the hardware processor 102 such as a central processing unit (CPU). Any of the processing resources may operate to execute code that is either firmware or software code. Moreover, the information handling system 100 may include memory such as main memory 106, static memory 108, and disk drive unit 120 (volatile (e.g., random-access memory, etc.), nonvolatile memory (read-only memory, flash memory etc.) or any combination thereof or other memory with computer readable medium 110 storing instructions (e.g., software algorithms), parameters, and profiles 112 executable by the EC 104, hardware processor 102, GPU 103, or any other hardware processing device. The information handling system 100 may also include one or more buses 118 operable to transmit communications between the various hardware components such as any combination of various I/O devices 142 as well as between hardware processors 102, an EC 104, the operating system (OS) 116, the basic input/output system (BIOS) 114, the wireless interface adapter 128, or a radio module, among other components described herein. In an embodiment, the information handling system 100 may be in wired or wireless communication with the I/O devices 142 such as a docking station 151, a keyboard 146, a mouse 152, video display device 144, stylus 148, a microphone 153, a camera 154 such as a webcam, an external speaker or headset 155, or trackpad 150 among other peripheral devices any combination of which may form one or more various peripheral device workspaces according to embodiments herein.

The information handling system 100 further includes a video/graphics display device 144. The video/graphics display device 144 in an embodiment may function as a liquid crystal display (LCD), an organic light emitting diode (OLED), a flat panel display, a projector device to which a plurality of information handling systems may operatively couple, or a solid-state display. It is appreciated that the video/graphics display device 144 may be wired or wireless and may be an external video/graphics display device 144 that allows a user to increase the desktop area by extending the desktop, or for a plurality of information handling systems to share video for display via a projector in various embodiments. Additionally, as described herein, the information handling system 100 may include or be operatively coupled to one or more other I/O devices 142 including the wired or wireless mouse 152 described herein that allows the user to interface with the information handling system 100 via the video/graphics display device 144, a cursor control device (e.g., a trackpad 150, or gesture or touch screen input), a stylus 148, a microphone 153, a camera 154 such as a webcam, an external speaker or headset 155, and/or a keyboard 146, among others. Information handling system 100 may also be operatively coupled to a peripheral device 142 such as a docking station 151 or other smart peripheral device having a hardware processing device such as a hardware processor, microcontroller, or other hardware processing resource and which may further be operatively coupled to one or more additional peripheral devices 142. As described herein, each of these input/output devices 142 may each be a node device associated with the information handling system 100 and may be part of a peripheral device workspace defined and identified with a peripheral device workspace identification value via execution of the ecosystem manageability service module 168 and cloud manageability orchestrator module 166, as described in embodiments herein. Various drivers and hardware control device electronics may be operatively coupled to operate the I/O devices 142 according to the embodiments described herein. The present specification contemplates that the I/O devices 142 may be wired or wireless.

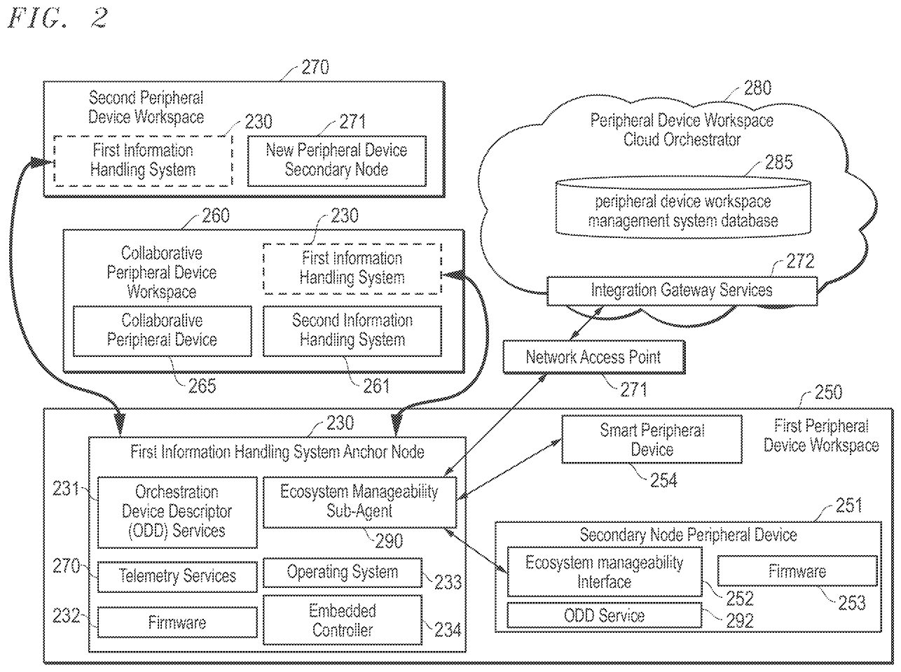

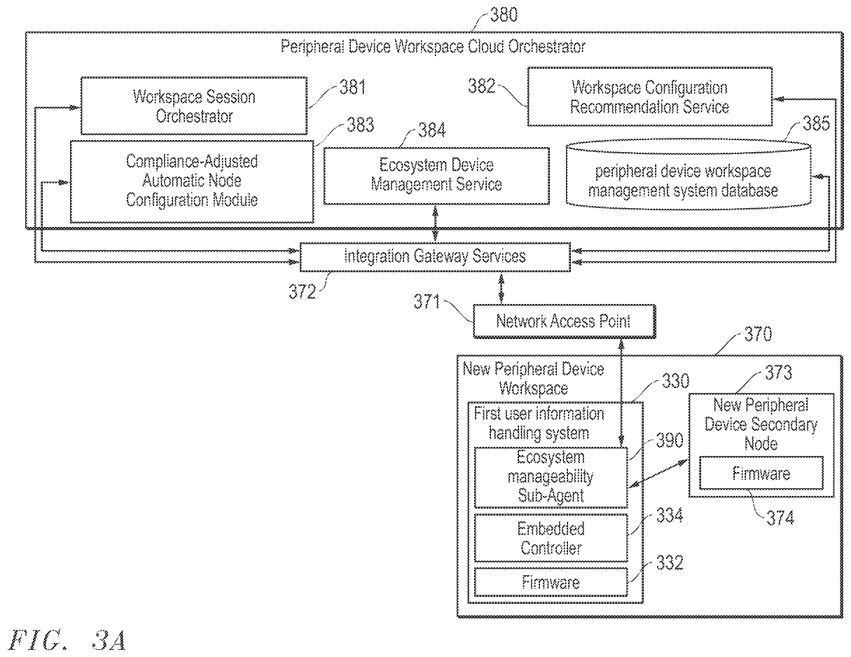

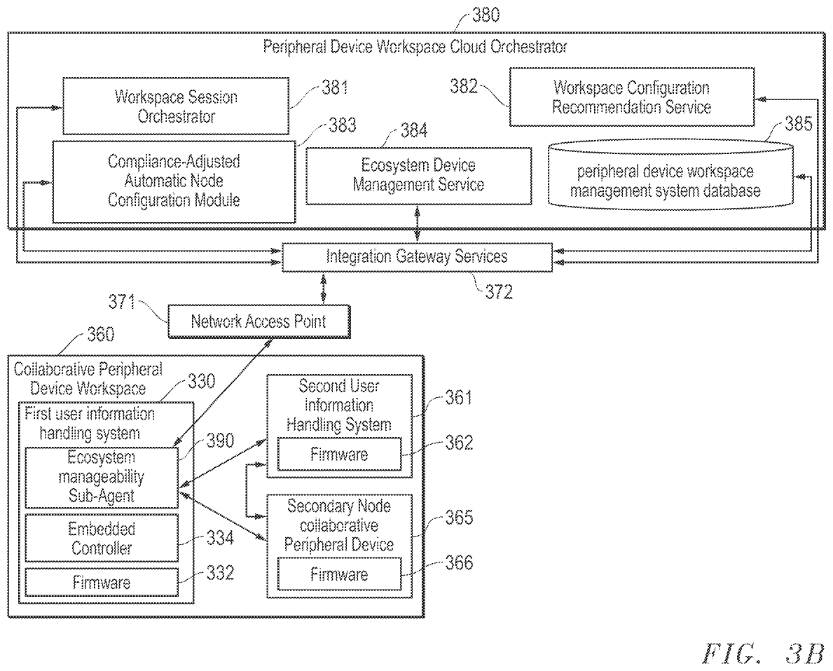

A network interface device of the information handling system 100 shown as wireless interface adapter 128 can provide connectivity among devices such as with Bluetooth® or to a network 136, e.g., a wide area network (WAN), a local area network (LAN), wireless local area network (WLAN), a wireless personal area network (WPAN), a wireless wide area network (WWAN), or other network. In an embodiment, this network 136 may be operatively coupled to or include a peripheral device workspace cloud orchestrator 156 that includes one or more servers (e.g., peripheral device workspace cloud orchestrator server 158) or other computing devices that provide computer system resources as described herein that allow for the creation and maintenance of peripheral device workspaces (e.g., as shown below in FIGS. 2, 3A and 3B) and orchestration of different node devices within one or more peripheral device workspaces. In embodiments described herein, the wireless interface device 128 with its radio 130, RF front end 132 and antenna 134 is used to communicate with the wireless peripheral devices via, for example, a Bluetooth® or Bluetooth® Low Energy (BLE) protocols. In an embodiment, the WAN, WWAN, LAN, and WLAN may each include an AP 138 or base station 140 used to operatively couple the information handling system 100 to a network 136. In a specific embodiment, the network 136 may include macro-cellular connections via one or more base stations 140 or a wireless AP 138 (e.g., Wi-Fi), or such as through licensed or unlicensed WWAN small cell base stations 140. Connectivity may be via wired or wireless connection. For example, wireless network wireless APs 138 or base stations 140 may be operatively connected to the information handling system 100. Wireless interface adapter 128 may include one or more radio frequency (RF) subsystems (e.g., radio 130) with transmitter/receiver circuitry, modem circuitry, one or more antenna radio frequency (RF) front end circuits 132, one or more wireless controller circuits, amplifiers, antennas 134 and other circuitry of the radio 130 such as one or more antenna ports used for wireless communications via multiple radio access technologies (RATs). The radio 130 may communicate with one or more wireless technology protocols.

In an embodiment, the wireless interface adapter 128 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 128 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes instructions, parameters, and profiles 112 or receives and executes instructions, parameters, and profiles 112 responsive to a propagated signal, so that a hardware device connected to a network 136 may communicate voice, video, or data over the network 136. Further, the instructions 112 may be transmitted or received over the network 136 via the network interface device or wireless interface adapter 128. It is appreciated that any computing device including the cloud orchestrator server 158, the cloud orchestrator console 160, and the information handling system 100 may include a computer-readable medium that includes instructions, parameters, and profiles 112.

The information handling system 100 may include a set of instructions 112 that may be executed to cause the computer system to perform any one or more of the methods or computer-based functions disclosed herein. For example, instructions 112 may be executed by a hardware processor 102, GPU 103, EC 104 or any other hardware processing resource and may include software agents, or other aspects or components used to execute the methods and systems described herein. Various software modules comprising application instructions 112 may be coordinated by an OS 116, and/or via an application programming interface (API). An example OS 116 may include Windows®, Android®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 112 in which one or more sets of machine-readable code instructions, parameters, and profiles 112 such as firmware or software can be embedded to be executed by the hardware processor 102 or other hardware processing devices such as a GPU 103 or EC 104, or other microcontroller unit to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 103 of information handling system 100.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 122 (a.k.a. a power supply unit (PSU)). The PMU 122 may include a hardware controller and executable machine-readable code instructions to manage the power provided to the components of the information handling system 100 such as the hardware processor 102 and other hardware components described herein. The PMU 122 may control power to one or more components including the one or more drive units 120, the hardware processor 102 (e.g., CPU), the EC 104, the GPU 103, a video/graphic display device 144, or other wired I/O devices 142 such as the mouse 152, the stylus 148, a microphone 153, a camera 154 such as a webcam, an external speaker or headset 155, a keyboard 146, and a trackpad 150 and other components that may require power when a power button has been actuated by a user. In an embodiment, the PMU 122 may monitor power levels and be electrically coupled to the information handling system 100 to provide this power. The PMU 122 may be coupled to the bus 118 to provide or receive data or machine-readable code instructions. The PMU 122 may regulate power from a power source such as the battery 124 or AC power adapter 126. In an embodiment, the battery 124 may be charged via the AC power adapter 126 and provide power to the components of the information handling system 100, via wired connections as applicable, or when AC power from the AC power adapter 126 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 is operatively coupled to a peripheral device workspace cloud orchestrator 156 that includes any number of servers, computing devices, and other cloud computing resources such as the peripheral device workspace cloud orchestrator server 158. The peripheral device cloud orchestrator 156 may, therefore, include any hardware that may be distributed over multiple physical locations but act in concert with each other and specifically the peripheral device workspace cloud orchestrator server 158 to facilitate maintenance and implementation of peripheral device operational configuration policies for a plurality of peripheral device workspaces, wherein the one or more node devices (e.g., including the information handling system 100 as an anchor node device, and one or more peripheral device nodes such as I/O devices 142) form part of each peripheral device workspace, create or adjust peripheral device operational configuration policies based on the registered node devices detected within the one or more created peripheral device workspaces, and apply the peripheral device operational configuration policies to the created peripheral device workspace(s). It is appreciated that the node devices described herein may include each of the peripheral devices operatively coupled to the information handling system 100 acting as a primary or anchor node device and the workspaces created may be described as a peripheral device workspace.

The peripheral device workspace cloud orchestrator server 158 may be any computing device that may include similar elements as the information handling system 100 such as a memory device, a cloud orchestrator hardware processing device 170, a PMU, and other elements that allow the peripheral device workspace cloud orchestrator server 158 to execute code instructions of the cloud manageability orchestrator module 166, ecosystem manageability service module 168, additional node automatic node configuration module 169, and other software as described herein. In an embodiment, the peripheral device workspace cloud orchestrator server 158 may be operatively coupled to a peripheral device workspace cloud orchestrator console 160 graphical user interface. The peripheral device workspace cloud orchestrator console 160 graphical user interface may be used by the ITDM in some embodiments to create and propagate peripheral device operational configuration policies, or to set various threshold values such as the overall experience compliance rating threshold value described herein. It is appreciated that the peripheral device workspace cloud orchestrator console 160 graphical user interface may be presented at an information handling system and include a cloud orchestrator input device 162 and a cloud orchestrator video display device 164 that allows the ITDM to complete these processes and engage with the peripheral device workspace cloud orchestrator server 158 in an embodiment.

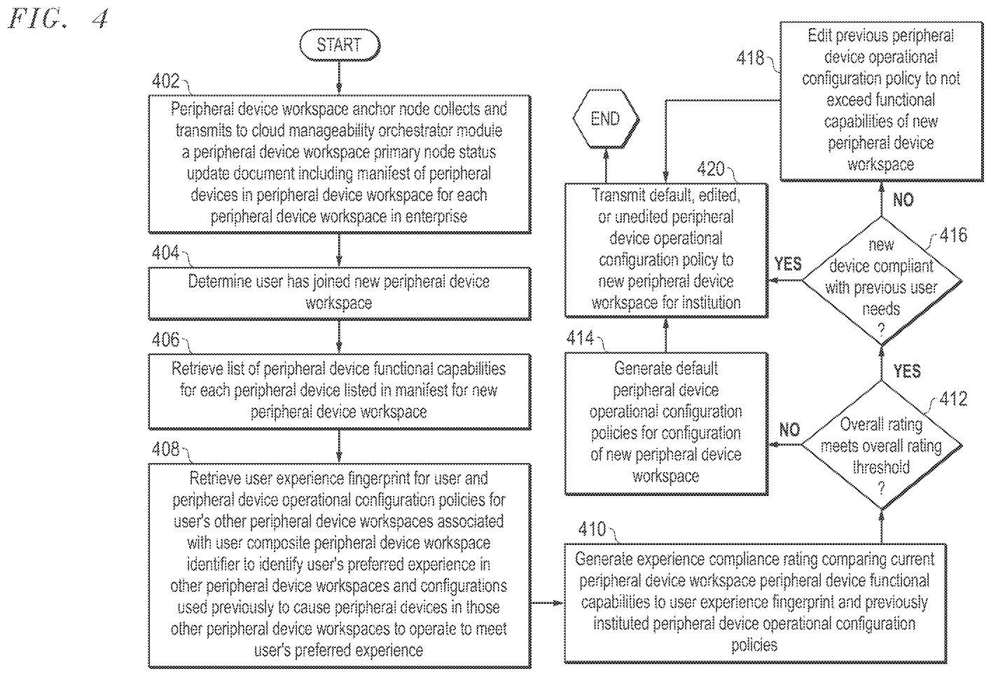

An ITDM for an enterprise, or the user of the information handling system 100 in an embodiment may use the console 160 graphical user interface to define a minimum experience compliance rating comparing capabilities between two comparable peripheral devices and a user experience fingerprint defining a user's expectation of functionality for one of the comparable peripheral devices from a previous usage in another peripheral device workspace that must match in order to recommend that two comparable peripheral devices be configured in the same way, as described in greater detail in embodiments herein such as with respect to FIGS. 3A and 4.

For example, a user or an ITDM may use the peripheral device workspace cloud orchestrator console 160 graphical user interface to require that 80 percent of functional capabilities or configuration settings for two separate peripheral devices where one has been used and recorded in the user experience fingerprint defining a user's expectation of functionality for the comparable peripheral device be overlapping to one another in order to recommend that the comparable devices be configured according to the same peripheral device workspace operational configuration policy that defines one or more adjustable operational configurations for the comparable devices. This is only an example of one threshold value, and other minimum requirements for identity of functional capabilities between comparable peripheral devices in embodiments may include any value from one to one hundred (e.g., 50%, 75%, 90%, etc.). A scoring system may be determined by execution of code instructions on the peripheral device workspace cloud orchestrator system from the orchestration device descriptor (ODD) of peripheral devices to determine number of overlapping capabilities for peripheral devices as well as available configuration setting levels in environmental context data for those capabilities including operational configurations (e.g., sampling speeds, resolution levels, processing or memory (if any), or others) and connectivity configurations (e.g., wireless protocols, wired protocols, connector ports, etc.) when used at a peripheral device workspace as recorded in an experience identification (xID) for a user. The ODD for existing peripheral devices or the new peripheral devices further includes a description of all non-configurable aspects of the peripheral device, as well as the configurable capabilities of such a peripheral device, a unique peripheral device identifier such as a serial number, and a peripheral device type classification (e.g., mouse, display, keyboard, webcam, etc.). Much of this ODD data and other data determined from the peripheral device workspace identification values for particular peripheral device workspaces may come from environmental context data collected via telemetry from a peripheral device workspace during usage of the peripheral device.

As described herein, the peripheral device workspace cloud orchestrator server 158 includes a computer-readable program code of a peripheral device workspace cloud manageability orchestrator module 166 that, when executed by the cloud orchestrator hardware processing device 170 of the peripheral device workspace cloud orchestrator server 158, manages creation and adjustment of peripheral device operational configuration policies for one or more node devices. In embodiments of the present specification and in the appended claims, a peripheral device workspace may be an ecosystem at a location with a location identifier of node devices (e.g., including peripheral devices coupled to the information handling system 100, a docking station 151, etc.) connected to a primary or anchor node device such as the information handling system 100. In an embodiment, a peripheral device workspace may also be defined with a peripheral device workspace identification value and be part of one or more peripheral device workspaces associated with a user composite peripheral device workspace identifier for a user who has operated in those peripheral device workspaces. The user composite peripheral device workspace identifier associates each of the information handling system 100 and peripheral devices (e.g., input/output devices 142) such that a user may have multiple peripheral device workspaces having peripheral device workspace identification values that are associated with the user usage in those peripheral device workspaces based on the environment context data of each identified peripheral device workspace.

For example, a user composite peripheral device workspace identifier may be used to define a first peripheral device workspace at a home office having a first peripheral device workspace identification value, a second peripheral device workspace at a work office having a second peripheral device workspace identification value, a third peripheral device workspace that may be collaborative at a different location (e.g., a conference room) having a third peripheral device workspace identification value, and other peripheral device workspaces that can be defined by both the node devices included within the peripheral device workspace and the location of the peripheral device workspace (e.g., defined by location data such as GPS data, network data, or other data to link to a physical location) and having a peripheral device workspace identification value.

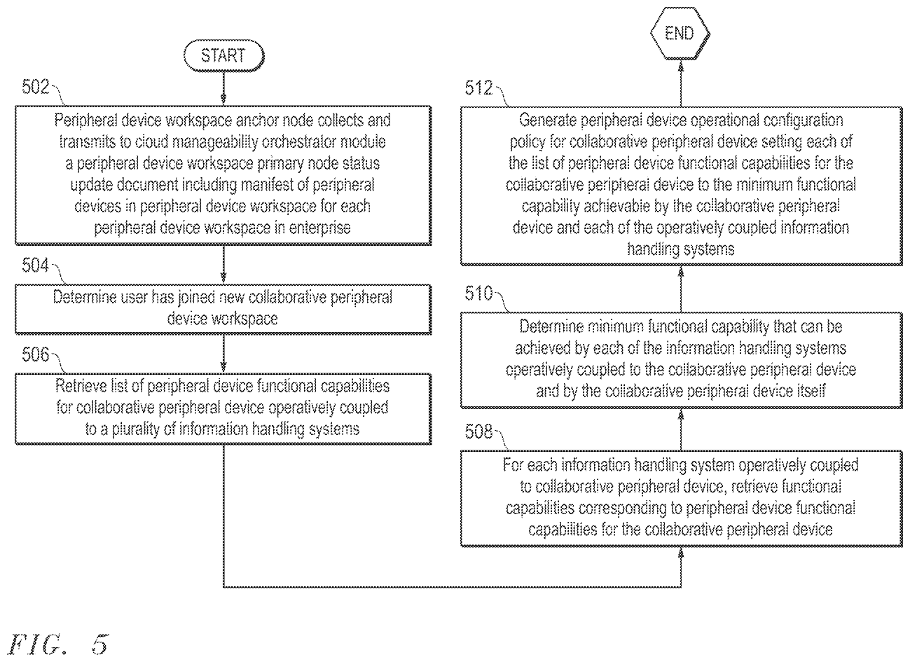

An ITDM for an enterprise, or the user of the information handling system 100 in an embodiment may also use the console 160 graphical user interface to define a minimum percentage of features or capabilities between two comparable peripheral devices or a minimum percentage of peripheral device unique identifiers that must match in order to recommend that two comparable peripheral devices be configured in the same way, as described in greater detail below with respect to FIGS. 3 and 5. For example, a user or an ITDM may use the peripheral device workspace cloud orchestrator console 160 graphical user interface to require that 80 percent of functional capabilities for two separate peripheral devices overlap one another in order to recommend that both devices be configured according to the same peripheral device workspace operational configuration policy that defines one or more adjustable operational configurations for the two comparable devices. This is only an example of one threshold value, and other minimum requirements for identity of functional capabilities between two different peripheral devices in embodiments may include any value from one to one hundred (e.g., 50%, 75%, 90%, etc.). In some embodiments, similarity of the overall peripheral device workspace and configuration of its nodes are considered. For example, an ITDM for an enterprise may use the peripheral device workspace cloud orchestrator console 160 graphical user interface to require that 50 percent of peripheral devices for two separate peripheral device workspaces (e.g., including 101) be overlapping with one another in order to recommend that devices in both peripheral device workspaces be configured according to the same peripheral device workspace operational configuration policy that defines one or more adjustable operational configurations for the two comparable peripheral devices. This is only an example of one threshold value, and other minimum requirements for identity of peripheral devices between two different peripheral device workspaces in embodiments may include any value from one to one hundred (e.g., 20%, 30%, 60%, etc.).

A scoring system may determine an user experiential compliance value by execution of code instructions on the peripheral device workspace cloud orchestrator system from the ODD of peripheral devices to determine number of overlapping capabilities for peripheral devices as well as available configuration setting levels in environmental context data for those capabilities including operational configurations (e.g., sampling speeds, resolution levels, processing or memory (if any), or others) and connectivity configurations (e.g., wireless protocols, wired protocols, connector ports, etc.). The required overlap in percentage or number of overlapping capabilities for peripheral devices, available configuration setting levels, operational configurations, and connectivity configurations may be a defined user experiential compliance value threshold for recommending settings and configurations from a previous peripheral device node be used in a currently-considered, new peripheral device node being compared. The ODD for existing peripheral devices or the new peripheral devices further includes a description of all non-configurable aspects of the peripheral device, as well as the configurable capabilities of such a device, a unique peripheral device identifier such as a serial number, and a peripheral device type classification (e.g., mouse, display, keyboard, webcam, etc.). Much of this ODD data and data determined from the peripheral device workspace identification values for particular peripheral device workspaces may come from environmental context data collected via telemetry from a peripheral device workspace.

In an embodiment, the execution of computer-readable program code of the peripheral device workspace cloud manageability orchestrator module 166 causes the peripheral device workspace cloud orchestrator server 158 to receive, create, or adjust peripheral device operational configuration policies based on the registered node devices detected within the one or more created peripheral device workspaces having peripheral device workspace identification values. In some embodiments, the peripheral device operational configuration policies may be received from the peripheral device workspace cloud orchestrator console 160 graphical user interface as initiated by the ITDM or may be initiated automatically in embodiments where a policy is provided based on previous usage of a peripheral device node meeting a user experiential compliance value threshold or other systems for automatically adjusting settings and configurations. The ITDM may be any information technology decision maker that may decide the peripheral device operational configuration policies to be associated with peripheral device workspaces formed at the peripheral device workspace cloud orchestrator server 158 and having peripheral device workspace identification values. In other example embodiments, these settings may be set by the peripheral device workspace cloud manageability orchestrator module 166 to a default configuration determined based on identified capabilities of a given peripheral device, as described herein. In various other embodiments herein, existing peripheral device operational configuration policies that have been previously applied in previously used peripheral device workspaces may be adjusted or edited by a capability-adjusted automatic node configuration module 169, as described in greater detail below and with respect to FIGS. 3A, 3B, 4, and 5.

In various embodiments herein, the peripheral device workspace cloud orchestrator console 160 may propagate these peripheral device operational configuration policies to the peripheral device workspace cloud orchestrator server 158 executing the peripheral device workspace cloud manageability orchestrator module 166. Upon receipt of these peripheral device operational configuration policies created at the peripheral device workspace cloud orchestrator console 160 graphical user interface by the ITDM, by the peripheral device workspace cloud manageability orchestrator module 166, and potentially adjusted or edited by the capability-adjusted automatic node configuration module, the execution of the peripheral device workspace cloud manageability orchestrator module 166 may propagate these peripheral device operational configuration policies to each of the device nodes within the created peripheral device workspace.

In an embodiment, the peripheral device workspace cloud orchestrator server 158 may also execute computer readable program code of an ecosystem manageability service module 168. Execution of the ecosystem manageability service module 168 applies the peripheral device operational configuration policies to the created peripheral device workspace. In an embodiment, the peripheral device workspace cloud manageability orchestrator module 166 creates, and the capability-adjusted automatic node configuration module 169 may adjust peripheral device operational configuration policies for each of the one or more node devices within the peripheral device workspace based on execution of software modules of embodiments herein. As described herein, the ecosystem manageability service module 168 may identify those peripheral devices 142 that form part of the peripheral device workspace having a peripheral device workspace identifier value and may propagate those peripheral device operational configuration policies that apply to those peripheral devices. For example, where a plurality of peripheral device workspaces with a plurality of peripheral device workspace identifier values each include a specific wireless mouse for which a peripheral device operational configuration policy has been created or updated, the execution of the computer-readable program code of the ecosystem manageability service module 168 causes the peripheral device workspace cloud orchestrator server 158 to send those peripheral device operational configuration policies to the appropriate peripheral device workspace (e.g., to each of the primary or anchor node devices 100) so that those peripheral device operational configuration policies may be passed to the wireless mice in each peripheral device workspace having a peripheral device workspace identifier value where such as specific mouse model or type is located.

A node device database operatively coupled to the peripheral device workspace cloud orchestrator server 158 may provide the peripheral device workspace cloud orchestrator server 158 with details regarding the node devices detected, including ODD and associated data. Further, peripheral device workspace cloud orchestrator server 158 executed code instructions for forming the peripheral device workspaces and associated particular peripheral device workspace identification values described herein for storage in an operatively coupled database accessed by the peripheral device workspace cloud orchestrator 156 of embodiments herein. In an example embodiment, the node device database may be part of the peripheral device workspace management database 167 shown in FIG. 1. For example, the node device database may include data regarding the possible settings for any given node device, compatibility of these node devices with other node devices within any given peripheral device workspace, and capabilities of the node devices among other characteristics and features of the node devices.

An information handling system 100 that is operatively connected to one or more peripheral devices 142 in an embodiment may operate as an anchor node for the peripheral device workspace and it may “own” or serve as a primary node for operative coupling to the secondary one or more peripheral device nodes 142. The user anchor information handling system 100 gathers capabilities and peripheral device operational and environmental context telemetry readings about all of the peripheral device nodes 142 within a given peripheral device workspace, as described directly below, and communicates that peripheral device operational and environmental context telemetry readings to the cloud manageability orchestrator module 156. Further, the anchor information handling system 100 receives peripheral device operational configuration policies describing how to configure the peripheral device nodes 142 and the anchor node information handling system 100 itself, and implements peripheral device operational configuration policies within the peripheral device workspace. As a single anchor information handling system moves between a plurality of peripheral device workspaces, the capability-adjusted automatic node configuration module 169 may determine the best or most appropriate peripheral device operational configuration policies for a given peripheral device workspace, based on previously defined peripheral device operational configuration policies set by an ITDM, by a user, or automatically set for various other peripheral devices 142 previously used in previous peripheral device workspaces through a comparison of capabilities for the nodes within the new peripheral device workspace according to embodiments herein. Such a determination may further depend upon the peripheral device operational and environmental context telemetry readings, which may include, for example, time of day, applications being executed, wireless or wired connection capabilities, or security credentials for the user. In such a way, execution of code instructions of the additional node automatic node configuration module may automatically update peripheral device configurations for newly added nodes within a peripheral device workspaces or entry into new peripheral device workspaces to match current peripheral device operational and environmental context telemetry readings. Such comparison for a new peripheral device node or entry into a new peripheral device workspace may be made with existing peripheral device nodes from previous experience fingerprints of a user and previous usages in other peripheral device workspaces from experience identification (xID) information stored for the user.

Execution of code instructions for an ecosystem manageability sub-agent 172 on a user information handling system 100 monitors for sets of environmental context data of a peripheral device workspace, such as time, applications currently executing or planned, hardware component usage metrics, connection type (e.g., wireless, wired, wireless wide area network (WWAN), wireless local area network (WLAN), wireless private area network (WPAN)), security credentials for the user, or environmental sensor readings (e.g., humidity, temperature, ambient light), among other possible peripheral device operational and environmental context telemetry readings for the information handling system node 100 and peripheral device nodes 142 in a peripheral device workspace. These peripheral device operational and environmental context telemetry readings associated with a peripheral device workspace identification value may be gathered routinely in telemetry measurements such as upon each startup of an anchor information handling system 100 in a peripheral device workspace, for example. The ecosystem manageability sub-agent 172 executing at the information handling system 100 in a peripheral device workspace may create a manifest of peripheral device nodes 142 and other nodes for a peripheral device workspace identification value to represent the current peripheral device workspace, including an identification of a location, identification of the user, and an identification (e.g., by product serial number or other peripheral device identification) of each of the peripheral device nodes 142 connected to or operably coupled to the anchor information handling system 100 at a peripheral device workspace. Identification of the each of the peripheral device nodes 142 may include or be associated with an ODD in various embodiments herein.

Peripheral device operational and environmental context telemetry readings gathered pursuant to execution of code instructions for an ecosystem manageability sub-agent 172 in an embodiment may include, for example, information specific to the information handling system 100, or the operative connection between the information handling system 100 and the peripheral devices 142, when in one or another peripheral device workspace. More specifically, the peripheral device operational and environmental context telemetry readings gathered pursuant to execution of code instructions for the ecosystem manageability sub-agent may include, for the information handling system 100, a current power mode (e.g., sleep mode, battery mode, operational mode, powered down), range of possible power modes, current time, geographic location for the peripheral device workspace that includes the information handling system 100, current execution of a specific software application, hardware processor 102 or 104 utilization rate, memory 106, 108, or 120 utilization rate, remaining battery power for battery 124.

The peripheral device workspace anchor node in an embodiment may generate and transmit to the cloud manageability orchestrator module a peripheral device workspace anchor node status update document including manifest of peripheral devices in peripheral device workspace and collected peripheral device operation and environmental context telemetry readings for a peripheral device workspace location identified by a location identifier. For example, code instructions for the ecosystem manageability sub-agent 172 executing at the information handling system 100 in a peripheral device workspace may create a manifest of peripheral device nodes 142 and other nodes for a peripheral device workspace identification value to represent the current peripheral device workspace, including an identification of the user, and an identification (e.g., by product serial number or other peripheral device identification) of each of the peripheral device nodes 142 connected to or operably coupled to the anchor information handling system 100 at a peripheral device workspace.

The hardware processor 102 of the user anchor information handling system 100 may execute code instructions of the ecosystem manageability sub-agent 172 to also collect one or more peripheral device operational and environmental context telemetry readings (e.g., time, applications executing, hardware component usage metrics, or other telemetry data indicating usage patterns for the information handling system 100 or various peripheral devices 142 in a peripheral device workspace). The manifest of peripheral device nodes and other nodes as well as location of a peripheral device workspace described above may be combined with the peripheral device operational and environmental context telemetry readings for the peripheral device workspace and an identification of the anchor node information handling system 100 user into a peripheral device workspace anchor node status update document written in a machine-readable language or machine markup language such as JavaScript Object Notation (JSON), for example, to be associated with a peripheral device workspace identification value.

This peripheral device workspace anchor node status update document is transmitted for storage with the peripheral device workspace identification value at a peripheral device workspace management system database 167 operating in the peripheral device workspace cloud orchestrator 156. Each time a peripheral device configuration setting is changed by the user, a new peripheral device is added to the peripheral device workspace, the peripheral device workspace anchor node information handling system moves to a new peripheral device workspace, or changes to environmental context data for the peripheral device workspace are detected, a new peripheral device workspace anchor node status update document including this updated configuration may be transmitted to the peripheral device workspace cloud orchestrator 156 for association with the peripheral device workspace identification value for the peripheral device workspace. Additionally, values for the ODD of each peripheral device in the manifest of peripheral devices in the peripheral device workspace may also be updated with these changes. Similarly, a given set of configuration settings operated by a user for a period of time may establish an xID for the user's user composite peripheral device workspace identifier to record usages of the peripheral devices during sessions by a user in a peripheral device workspace.

The peripheral device workspace management system database 167 may further store a user composite peripheral device workspace identifier that is unique to individual users of one or more defined peripheral device workspaces that are associated with identification of the user of the user's information handling system 100 and peripheral device workspace identification values of the peripheral device workspaces used by that user. Thus, a user composite peripheral device workspace identifier may identify a single user of an anchor node information handling system 100, and a peripheral device workspace identification value for each of one or more peripheral device workspaces in which the user's information handling system 100 operates as an anchor node at various times. The user composite peripheral device workspace identifier may also be associated with one or more xIDs identifying user experience fingerprints for usages by a user during sessions at peripheral device workspaces as described in embodiments herein. The user composite peripheral device workspace identifier may thus be user-specific and user-centric. The peripheral device workspace identification value, in comparison, may define a location and list of peripheral device nodes 142, and may thus be peripheral device workspace-centric. Each user composite peripheral device workspace identifier may be associated with a single user, and may further include one or more user experience fingerprints with a user experience identifier (xID) defining usage patterns or the ways in which the single user uses the anchor node information handling system 100 and one or more peripheral devices 142 within defined peripheral device workspaces in which the single user operates during usage sessions at peripheral device workspaces.

A user experience fingerprint may include a list of peripheral device nodes 142 within a defined peripheral device workspace associated with a peripheral device workspace identification value and the user's composite peripheral device workspace identifier, as well as capabilities for each of those listed peripheral devices 142, and at least one peripheral device operational and environmental context telemetry readings of the peripheral device workspace describing a pattern of usage for the specific user of the anchor node information handling system 100. The at least one peripheral device operational and environmental context telemetry readings of the peripheral device workspace describing a pattern of usage records the setting and configurations established by a user at a peripheral device workspace and records the activity being conducted, such as gaming, workplace proficiency software execution for various work activities, teleconference meetings, or the like. The user experience fingerprint may be used to link usage patterns for the anchor node information handling system 100 (e.g., execution of specific software applications or high usage rates for various hardware components at the anchor node) with the capabilities and settings for the operatively coupled peripheral devices 142 within the peripheral device workspace.

As described herein, when users shift from a personalized peripheral device workspace to a shared peripheral device workspace (e.g., hoteling office) or collaborative peripheral device workspace (conference room), there is often a mismatch between the capabilities for the peripheral devices within the shared peripheral device workspace or collaborative peripheral device workspace and the capabilities or configurations for the peripheral devices within the users' personalized peripheral device workspaces. The cloud-based server 158 executing code instructions of the compliance-adjusted automatic node configuration module 169 in an embodiment may leverage the user experience fingerprints for each of such users, as described directly above, to more accurately match the capabilities and configurations of the peripheral devices 142 within the shared peripheral device workspace or collaborative peripheral device workspace with the capabilities and configurations of the peripheral devices within the users' personalized peripheral device workspaces, as described in greater detail below with respect to FIGS. 3A and 4. In such a way, the shared peripheral device workspace or collaborative peripheral devices 142 within the shared or collaborative peripheral device workspace may be configured to most closely match the users' desired experiences and workload needs, as defined within each users' xID.

In the case where multiple users are simultaneously sharing or are operatively coupled to the same collaboration peripheral device, such as a conference room projector 144, it may be desirable to configure the collaboration peripheral device 144 in a way that each of the operatively coupled users may interact with it in a similar fashion. For example, a conference room projector 144 may be capable of display according to a plurality of resolutions, including a 3840×2160 pixel 4K ultra high definition (4K UHD) resolution. However, not all users operatively coupled to the conference room projector 144 at a given time may be capable of output from their information handling systems (e.g., including 100) to the conference room projector 144 in 4K UHD resolution. One of the plurality of information handling systems, such as 100, may be only capable of output having a highest possible resolution of sub-high definition 1920×1080 pixels while other user anchor information handling system nodes can accommodate the same or higher. In such a case, it may be desirable to configure the collaboration peripheral device (e.g., conference room projector 144) to display at the 1920×1080 pixel resolution at which all of the users' information handling systems, including 100, currently operatively coupled to the collaboration peripheral device 144 are compatible rather than at a higher resolution level.

Code instructions for the compliance-adjusted automatic node configuration module 169 in an embodiment may execute to identify, for each of the collaborating user information handling systems (e.g., including 100) that have joined the collaborative peripheral device workspace, capabilities of each of the collaborating users' information handling systems, as given within the received peripheral device workspace anchor node status update document. In order to provide the same user experience to each of the user information handling systems (e.g., including 100) within the detected collaborative peripheral device workspace, code instructions for the compliance-adjusted automatic node configuration module 169 may execute to configure the collaborative peripheral device therein, such as the conference room projector 144, for use by all coupled users' information handling systems 100 simultaneously, as described in greater detail below with respect to FIGS. 3B and 5. In such a way, execution of code instructions of the compliance-adjusted automatic node configuration module 169 may automatically configure collaborative peripheral devices such as conference room projector 144 for use by all collaborating and operatively coupled user information handling systems at a level that each user information handling system can accommodate while meeting some minimum of user experience expectations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

FIG. 2 is a block diagram illustrating a cloud-based peripheral device workspace cloud orchestrator for defining a first of a plurality of peripheral device workspaces in which a user information handling system operatively couples with a first plurality of peripheral devices according to an embodiment of the present disclosure. As described previously, a user may oftentimes use an information handling system 230 in a peripheral device workspace 250. In this context, a peripheral device workspace 250, 260, or 270 can be viewed as an environment with a location identifier that includes the user information handling system 230 (e.g., a laptop) operating as a primary or anchor node for the peripheral device workspace 250 and peripheral devices 251 and 254 operating as secondary nodes of the peripheral device workspace 250 that are connected to the user information handling system 230. A set of environmental context data may be determined for each peripheral device workspace 250, 260, or 270 and may include, for example, location, time of day, applications being executed, wireless or wired connection capabilities, or security credentials for the user. Peripheral devices 251 and 254 may commonly include internal or external devices such as displays, a keyboard, a mouse, a webcam, a printer, a speaker, a fingerprint scanner, etc. According to various embodiments herein, a peripheral device workspace 250, 260, or 270 may include a wired or wireless dock by which the user information handling system 230 connects to some or all the peripheral devices including smart peripheral devices such as 254 having some compute or input/output capabilities. Peripheral device 254 in an example embodiment may considered a “smart” peripheral device because it may operate an agent or firmware, and include a network interface device or wireless receiver that makes the smart peripheral device 254 capable of direct communication with the cloud-based peripheral device workspace cloud orchestrator 280 via the integration gateway services 272 and the network access point 271 for some subset of secondary nodes. Similarly, a primary or anchor node information handling system 230 is also capable of direct communication with the cloud-based peripheral device workspace cloud orchestrator 280 via the integration gateway services 272 and the network access point 271 for some or all secondary nodes in the peripheral device workspace 250, 260, or 270.

A peripheral device workspace 250, 260, or 270 may oftentimes be used for hybrid work scenarios. For example, a business may have an office space that includes hoteling cubes that can be assigned to, reserved by, or otherwise utilized by the business's employees as peripheral device workspaces 250 or 270. In such cases, the business may allow its employees to connect their laptops (e.g., 230) to a dock (e.g., 254) in a particular hoteling cube where various peripherals (e.g., 251) may be available for use. A business may also have a collaborative peripheral device workspace 260 that may be a conference room or meeting room where plural users with plural anchor node information handling systems 230 utilize some or all peripheral device nodes in that peripheral device workspace at the same time. Users may also employ peripheral device workspaces 250, 260, or 270 when working from home or other locations.

When a user employs multiple peripheral device workspaces 250, 260, or 270 (e.g., by connecting a laptop to different combinations of peripheral devices during a workday), it can be tedious for the user to configure the peripheral device workspaces 250, 260, or 270 to his or her preferences. For example, while using a first peripheral device workspace 250, the user may set configurations for the peripheral devices 251 and 254 of the peripheral device workspace 250 to match the user's preferences or they may be configured to meet an operating policy set by an ITDM for a given peripheral device workspace. If the user switches to a different peripheral device workspace 260 or 270, those configurations may not be consistent with the peripheral devices 265 or 271, respectively, of the different peripheral device workspace 260 or 270 or may result in unintended changes. The user may therefore have to manually reconfigure the peripheral devices (not shown) within the peripheral device workspace 260 or 270.

As one particular example, a user may have a home peripheral device workspace 250 that includes a 4K monitor peripheral device 251 with 3840×2160 resolution at 60 Hz that is in landscape orientation and that also includes a 32-inch Full High Definition (FHD) monitor with 1920×1080 resolution that is in portrait orientation. This user may have set adjustable operational configurations for this home peripheral device workspace 250 to personalize these display devices. The user may also have access to multiple office peripheral device workspaces such as 270 (e.g., in a hoteling scenario), and these peripheral device workspaces such as 270 may have different sets of peripheral devices such as a first office peripheral device workspace with two display devices and a second office peripheral device workspace with a single display device or a conference room. If the user's adjustable operational configurations for the home peripheral device workspace 250 are applied to the office peripheral device workspace 270, the display device(s) will likely not be configured in accordance with the user's preferences. The user will then need to manually reconfigure the office peripheral device workspace 270 to achieve her preferences. When the user returns to her home peripheral device workspace 250, she may again be required to manually reconfigure the home peripheral device workspace 250. As can be seen, when using multiple peripheral device workspaces 250 and 270, personalized adjustable operational configurations for peripheral devices such as 251 are likely to be lost or misapplied due to the mismatching set of peripheral devices that make up the peripheral device workspaces 250 and 270. These issues arise in cases where the user switches between entirely different peripheral device workspaces 250 and 270 (e.g., when leaving home where a home peripheral device workspace is used to travel to work where an office peripheral device workspace is used) as well as in cases where the user creates a different peripheral device workspace 250 or 270 through the connection and/or disconnection of a peripheral device such as 251 or 254 (e.g., when connecting an external webcam to a dock or laptop that is part of an existing peripheral device workspace).

Execution of code instructions for an ecosystem manageability sub-agent 290 on a user information handling system 230 monitor telemetry readings taken by a telemetry service 270 for environmental context data of a peripheral device workspace, such as time, location, applications currently executing or planned, connection type (e.g., wireless, wired, wireless wide area network (WWAN), wireless local area network (WLAN), wireless private area network (WPAN)), security credentials for the user, or environmental sensor readings (e.g., humidity, temperature, ambient light), among other possible telemetry readings for the information handling system 230. These telemetry measurements may be gathered routinely, or upon each startup of an information handling system 230, for example.

Code instructions for the ecosystem manageability sub-agent 290 in an embodiment may execute to gather, via an ecosystem manageability interface 252 at one or more secondary node peripheral devices, such as 251, various peripheral device operational and environmental context telemetry readings describing operational capabilities for the one or more secondary node peripheral devices within the peripheral device workspace 250. For example, the code instructions for the ecosystem manageability sub-agent 290 operating at the anchor node 230 may execute to gather peripheral device operational and environmental context telemetry readings regarding the range of capabilities for each peripheral device (e.g., 251 and 254). The information defining the range of functional capabilities for the peripheral device 251 may be stored at the peripheral device 251, within the firmware 253, or at an orchestration device descriptor (ODD) service 292 and may also be transmitted to a cloud based peripheral device workspace management system database 285 or other database at the peripheral device workspace cloud orchestrator 280 executing on cloud-based servers. In an embodiment, the ODD service 292 the peripheral device 251 may also store static or non-adjustable features for the peripheral device 251, such as locations for various ports, physical dimensions of the new peripheral device 251, or physical locations for internal components such as an embedded camera. Model number, device number, media access control (MAC) address, or other identifying information for the peripheral device 251 may also be stored within the ODD service 292, or similar identifying information for the peripheral device 251 in an embodiment may be stored within firmware 253 and accessible by the ODD service 292. The ecosystem manageability sub-agent 290 of the anchor node information handling system 230 may execute code instructions in an embodiment to retrieve the functional capabilities for the peripheral device 251 from the firmware 253 via communication with the ecosystem manageability interface 252, which may act as an application programming interface (API), for example, between the firmware 253 and the ecosystem manageability sub-agent 290. The ODD may include a unique peripheral device identification as well as an environmental telemetry data set describing the peripheral device operational and environmental context telemetry readings regarding the range of capabilities for each peripheral device (e.g., 251 and 254).

Each peripheral device, such as 251 may include a range of capabilities, and the user may choose to configure the peripheral device 251 to operate according to a selected setting or configuration within this range of capabilities. For example, in an embodiment in which the peripheral device 251 is an external display device, the peripheral device 251 may be capable of operating within a range of functional capabilities defining the display resolution, such as between a resolution of 640×480 pixels, which may be the lowest resolution supported by the operating system 233, and 3840×2160 pixels, which is the standard resolution for 4K Ultra-High Definition (4K UHD) monitors. Thus, the functional capabilities for the peripheral device 251 in such an example may be the entire range between 640×480 pixels and 3840×2160 pixels. The user may select an adjustable operational configuration for the peripheral device 251 by choosing one available resolution within this range of 620×480 pixels and 3840×2160 pixels. This may be done by the user, for example, through a “preferences,” “properties,” or “settings” user interface within the operating system 233. Because the user may choose one of several available configurations within the range of functional capabilities, the chosen configuration may be referred to herein as an adjustable operational configuration that may be selected by the user. In some cases, the peripheral device 251 may be preset with a default configuration. These default configurations may also be considered adjustable operational configurations herein, in that the user has the opportunity to adjust such a default configuration through the “preferences,” “properties,” or “settings” user interface within the operating system 233. In such a way, the peripheral device 251 may be configured according to a user-selectable, adjustable operational configuration that lies within a range of functional capabilities for the peripheral device. Other capabilities may include connectivity capabilities for a peripheral device 251, such as types of wired connectors or wireless protocols available configuration may include selection of connectivity type as well as speeds or bandwidths available.

The anchor node information handling system 230 in an embodiment may also include a hardware processor or embedded controller 234 executing code instructions of the ecosystem manageability sub-agent 290. The anchor node 230 in an example embodiment may be operatively coupled to a secondary node peripheral device 251, which may further include a microcontroller executing code instructions of an ecosystem manageability interface 252 and firmware 253. The ecosystem manageability 252 in an embodiment may facilitate communication between the ecosystem manageability sub-agent 290 and the firmware 253 for the secondary node peripheral device 251. Although not shown in FIG. 2, the smart peripheral device 254 may further include internal components facilitating communication of telemetry measurements for the peripheral device 254 or other peripheral devices that may be secondary and operatively coupled to it to the ecosystem manageability sub-agent 290.

The ecosystem manageability sub-agent 290 in an embodiment may gather, via ecosystem manageability interface 252, various peripheral device operational and environmental context telemetry data readings describing adjustable configurations for the secondary node peripheral device 251 within the peripheral device workspace 250. For example, in an embodiment in which the peripheral device 251 is an external display device, the ecosystem manageability sub-agent 290 may gather telemetry information including a current adjustable operational configuration at the peripheral device 251 for display resolution, display refresh rate, brightness, contrast, color gamut, horizontal view angle, vertical view angle, and response time. As another example, in an embodiment in which the peripheral device 251 is an external webcam, the ecosystem manageability sub-agent 290 may gather telemetry information including a current adjustable operational configuration at the peripheral device 251 for audio/visual connection type (e.g., HDMI, digital audio, etc.), video capture resolution, image depth, video capture refresh rate, or captured frames per second. In still another example, in an embodiment in which the peripheral device 251 is an external microphone, the ecosystem manageability sub-agent 290 may gather telemetry information including a current adjustable operational configuration at the peripheral device 251 for audio output type, audio output frequency, or audio filters (e.g., noise reduction). In yet another example embodiment, in which the peripheral device 251 is an external speaker, the ecosystem manageability sub-agent 290 may gather telemetry information including a current adjustable operational configuration at the peripheral device 251 for audio input type, and audio input frequency. In yet another example embodiment, in which the peripheral device 251 is mouse, touchpad, touchscreen, or keyboard, the ecosystem manageability sub-agent 290 may gather telemetry information including a current adjustable operational configuration at the peripheral device 251 for polling rate, keystroke or button detection, sensitivity levels, power source levels and other settings. Other types of peripheral devices 251 are also contemplated and may include relevant current adjustable operational configuration telemetry data as environmental context data for any peripheral device types as described herein. A similar method of gathering telemetry for a smart peripheral device 254 may also be performed via the ecosystem manageability sub-agent 290 in an embodiment.

The ecosystem manageability sub-agent 290 executing at the information handling system 230 may create a manifest listing each of the peripheral device nodes 251 and 254 within the peripheral device workspace 250, as well as the anchor node 230. The manifest of peripheral device nodes 251 and 254 and other nodes 230 as well as location of a peripheral device workspace 250 may be combined with the peripheral device operational and environmental context telemetry readings for the peripheral device workspace 250 for capabilities and configuration settings and an identification of the anchor node information handling system 230 user into a peripheral device workspace anchor node status update document written in a machine-readable language or machine markup language such as JavaScript Object Notation (JSON), for example, for the peripheral device workspace. The peripheral device workspace anchor node status update document is transmitted for storage with the peripheral device workspace identification value at a peripheral device workspace management system database 285 operating in the peripheral device workspace cloud orchestrator 280. Each time a peripheral device configuration setting is changed by the user, a new peripheral device is added to the peripheral device workspace 250, the information handling system 230 moves from a first peripheral device workspace 250 to a second peripheral device workspace 260 or 270, or changes to environmental context data for the peripheral device workspace 250 are detected, a new peripheral device workspace 250 anchor node status update document including this updated configuration may be transmitted to the peripheral device workspace cloud orchestrator 280.

The anchor node information handling system 230 in an embodiment may be operatively connected to the internet via a network access point (AP) 271a, which may further connect to one or more cloud-based applications, servers, or systems of the peripheral device workspace cloud orchestrator 280. Such cloud-based applications in an embodiment may include the peripheral device workspace cloud orchestrator 280 which communicates with the remote anchor node information handling system 230 in various peripheral device workspaces 250 and 260, respectively, via an integration gateway service 272. The integration gateway service 272 in an embodiment may operate as an Application Programming Interface (API) or a Query Language (QL) supervisor to control communications to and from the peripheral device workspace cloud orchestrator 280, for example. More specifically, the integration gateway service 272 may, via an API, control the query language in which queries are made to the peripheral device workspace cloud orchestrator 280. As another example, the integration gateway service 272 may use a query language supervisor, such as GraphQL® to control such queries and the format in which results are provided by the peripheral device workspace cloud orchestrator 280. The anchor node 230 may communicate gathered peripheral device telemetry, as well as telemetry specific to the anchor node 230 itself, to the peripheral device workspace cloud orchestrator 280 via this integration gateway service 271a.

Various peripheral device workspaces (e.g., 250, 260, and 270) such as the hybrid work office peripheral device workspaces, collaborative peripheral device workspaces 260, and other peripheral device workspaces described herein may be defined by location indicator detected for an anchor node information handling system 230 operating at the peripheral device workspace 250, and a manifest of nodes of peripheral devices 251 and smart devices 254 that may operate in the peripheral device workspace 250. Each such defined peripheral device workspace 250, 260, or 270 may also be assigned a peripheral device workspace identification value which may be stored and associated with stored manifests of nodes 230, 251, and 254 operating in the peripheral device workspace 250. Additional environmental context data for the peripheral device workspace 250 may be stored within one or more peripheral device workspace anchor node status update documents as well as included in the definition of the peripheral device workspace and associated with its peripheral device workspace identification value defined at the peripheral device workspace cloud orchestrator 280 server database 285, including peripheral device capabilities, peripheral device connectivity details, current peripheral device configurations or settings, peripheral device setting or configuration options, current status of the peripheral devices 230, 251, and 254, within the peripheral device workspace 250, and other features of nodes 230, 251, and 254 within the peripheral device workspace 250. For example, the definition of the peripheral device workspace 250 associated with a specific peripheral device workspace identification value may include a set of environmental context data and stored within one or more peripheral device workspace anchor node status update documents, such as time, applications currently executing or planned, connection type, hardware component capabilities or usage metrics, or environmental sensor readings (e.g., humidity, temperature), among other possible environmental context telemetry readings for an anchor node information handling system 230 operating within the defined peripheral device workspace 250.

A peripheral device workspace 250 may be defined by a location, a list of peripheral devices 251 and 254 operatively coupled to an anchor node information handling system 230 for a user, type of peripheral device workspace (e.g., personal, hoteling office/shared, or collaborative), and additionally in some cases, by one or more of the environmental context data for the peripheral device workspace 250 described herein. Each of these defining factors may be associated in a database memory 285 for the peripheral device workspace cloud orchestrator 280 with the peripheral device workspace identification value, which may also be associated with one or more peripheral device operational configuration policies describing how the nodes 230, 251 and 254 within the defined peripheral device workspace 250 are to operate. Thus, a particular peripheral device operational configuration policy for one or more peripheral device nodes 251 or 254 within a given peripheral device workspace 250 having a peripheral device workspace identification value may apply only when certain environmental context telemetries, such as telemetries describing usage patterns for those peripheral device nodes 251 or 254 are detected. In such a way, the peripheral device operational configuration policy for a peripheral device such as 251 or 254 within a peripheral device workspace 250 may be defined or associated with particularly defined usage patterns for that peripheral device. For example, a peripheral device operational configuration policy may apply only when certain software applications are executing at the anchor node information handling system 230 defined within the peripheral device workspace 250, or when one or more hardware components' (e.g., graphics processing unit (GPU), central processing unit (CPU), memory) usage metrics or connectivity metrics meet a predefined threshold.

It is contemplated that each peripheral device workspace 250, 260, or 270 may be at any locations worldwide in which a user connects an information handling system 230 as an anchor node to one or more peripheral device 251 or 254 as secondary nodes. In a further aspect, peripheral device workspace 250, 260, or 270 may be in the same physical location, but may contain different groupings of an anchor node and one or more operatively coupled peripheral devices as independent peripheral device workspaces or be defined as independent meshes within a single peripheral device workspace. In a still further aspect, peripheral device workspace 250, 260, or 270 may be at different physical locations and may share the same anchor node 230 during different usage sessions. In other words, peripheral device workspace 250 may be located at the user's office, peripheral device workspace 270 may be located at the user's home, and a single laptop 230 may operate as the anchor node in both peripheral device workspace 250 and peripheral device workspace 270 at different times. In another example, peripheral device workspace 250 and peripheral device workspace 270 may both be located at the user's office but different offices, and may include the same laptop anchor node 230, but peripheral device workspace 250 and peripheral device workspace 270 may include different groups of peripheral devices. In another embodiment, a peripheral device workspace such as 250 may be located at the user's office but different meshes of different groups of peripheral device nodes may be used in the peripheral device workspace 250, for example, if the user routinely executes graphics intensive design applications and connects to a 4K high resolution display during the morning hours of each day in a first mesh subset of peripheral device nodes, then switches to use of a webcam and execution of videoconferencing applications in a second mesh subset of peripheral device nodes during the afternoon hours of each day.

A database memory 285 for the peripheral device workspace cloud orchestrator 280 may further store a user composite peripheral device workspace identifier that is unique to individual users of one or more defined peripheral device workspaces 250, 260, or 270 that are associated with identification of the user of the user's information handling system 230 and peripheral device workspace identification values of the peripheral device workspaces 250, 260, or 270 used by that user. Thus, a user composite peripheral device workspace identifier may identify a single user of an anchor node information handling system 230, and a peripheral device workspace identification value for each of one or more peripheral device workspaces 250, 260 or 270 in which the user's information handling system 230 operates as an anchor node at various times. The user composite peripheral device workspace identifier may thus be user-specific and user-centric. The peripheral device workspace identification value, in comparison, may define a location and list of peripheral device nodes, and may thus be peripheral device workspace-centric. Each user composite peripheral device workspace identifier may be associated with a single user such as the user of information handling system anchor node 230, and may further include one or more user experience fingerprints with a user experience identifier (xID) defining usage patterns or the ways in which the single user uses the anchor node information handling system 230 and one or more peripheral devices such as 251 and 254 within defined peripheral device workspaces 250, 260, or 270 in which the single user operates during usage sessions.

A user experience fingerprint, having an user experience identification (xID) may include a list of peripheral device nodes, such as 251 and 254, within a defined peripheral device workspace, such as 250, associated with a peripheral device workspace identification value and the user's composite peripheral device workspace identifier, as well as capabilities for each of those listed peripheral devices 251 and 254, and at least one peripheral device operational and environmental context telemetry readings of the peripheral device workspace 250 describing a pattern of usage for the specific user of the anchor node information handling system 230 during sessions of usage. The user experience fingerprint may be used to link usage patterns for the anchor node information handling system 230 (e.g., execution of specific software applications or high usage rates for various hardware components at the anchor node 230) with the capabilities and settings for the operatively coupled peripheral devices 251 and 254 within the peripheral device workspace 250.

As described herein, when users shift from a personalized peripheral device workspace such as 250 to a collaborative peripheral device workspace 270 or collaborative peripheral device workspace 260, there is often a mismatch between the capabilities for the peripheral devices, such as 271, or 265, respectively within the shared peripheral device workspace (e.g., a hoteling office) or collaborative peripheral device workspace 260 (e.g., a conference room) and the capabilities or configurations for the peripheral devices 251 and 254 within the users' personalized peripheral device workspaces 250. A cloud-based server executing code instructions of the compliance-adjusted automatic node configuration module within the peripheral device workspace cloud orchestrator 280 in an embodiment may leverage the user experience fingerprints from xIDs for each of such users, as described directly above, to more accurately match the capabilities and configurations of the peripheral devices 271 or 265, respectively within the shared or collaborative peripheral device workspaces 270 and 260 with the capabilities and configurations of the peripheral devices 251 and 254 within the users' personalized peripheral device workspaces 250, as described in greater detail below with respect to FIGS. 3A and 4. In such a way, the shared peripheral device nodes or the collaborative peripheral device nodes within the shared peripheral device workspace or collaborative peripheral device workspace may be configured to most closely match the users' desired experiences and workload needs, as defined within each users' xID according to embodiments herein.

In the case where multiple users are simultaneously sharing or are operatively coupled to the same collaboration peripheral device 265 within the collaborative peripheral device workspace 260, such as a conference room projector, it may be desirable to configure the collaboration peripheral device 265 in a way that each of the operatively coupled user information handling systems 230 and 261 may interact with it in a similar fashion. Code instructions for the compliance-adjusted automatic node configuration module may execute at the peripheral device workspace cloud orchestrator 280 to identify, for each of the collaborating user information handling systems 230 and 261 that have joined the collaborative peripheral device workspace 260, capabilities of each of the collaborating users' information handling systems 230 and 261, as given within a received peripheral device workspace anchor node status update document. In order to provide the same user experience to each of the user information handling systems 230 and 261 within the detected collaborative peripheral device workspace 260, code instructions for the compliance-adjusted automatic node configuration module may execute to configure the collaborative peripheral device 265, such as the conference room projector for use by all coupled users' information handling systems 230 and 261 simultaneously, as described in greater detail below with respect to FIGS. 3B and 5. In such a way, execution of code instructions of the compliance-adjusted automatic node configuration module may automatically configure collaborative peripheral device nodes such as conference room projectors in a way with a minimum level of capabilities that may be accommodated by all collaborating and operatively coupled user information handling systems.

As shown in FIG. 2, the user may already have previously operatively coupled to one or more already-established or pre-existing peripheral device nodes, such as 251 and 254, operatively coupled to the anchor node information handling system 230 within the peripheral device workspace 250. These established or pre-existing peripheral devices such as 251 and 254, to which the user information handling system 230 has been operatively coupled prior to transition of the information handling system 230 to the second peripheral device workspace 270 or the collaborative peripheral device workspace 260, may be referred to herein as “previous peripheral devices,” and the functional capabilities for these existing peripheral devices 251 and 254 may be referred to herein as “previous peripheral device functional capabilities.” In contrast, the functional capabilities for the new peripheral device secondary node 271 within the second peripheral device workspace 270 to which the user later transitions may be referred to herein as “new peripheral device functional capabilities.” It is contemplated that the existing peripheral devices, such as 251 or 254 may also include ODD services with an assigned ODD for each.

FIG. 3A is a block diagram illustrating code instructions for a peripheral device workspace cloud orchestrator executing at a remote peripheral device workspace cloud orchestrator server or servers for automatically configuring a new peripheral device using previously user-selected adjustable operational configurations from a matching peripheral device node in a previously used peripheral device workspace associated with the user according to an embodiment of the present disclosure. As described previously, when users shift from a personalized peripheral device workspace, such as 250 in FIG. 2 above, to a new peripheral device workspace 370, there is often a mismatch between the capabilities for the peripheral devices such as 373 within the new peripheral device workspace 370 and the capabilities or configurations for the peripheral devices, such as 251 or 254 in FIG. 2 within the users' personalized peripheral device workspaces, such as 250 in FIG. 2. A cloud-based server executing code instructions of the compliance-adjusted automatic node configuration modules 383 in embodiments herein may leverage the user experience fingerprints for each user of an anchor information handling system 330, as described above with respect to FIG. 2, to more accurately match the capabilities and configurations of the peripheral devices such as 373 within the new peripheral device workspace 370 with the capabilities and configurations of the peripheral devices, such as 251 and 254 within the users' personalized peripheral device workspaces, such as 250. In such a way, the new peripheral devices, such as 373 within the new peripheral device workspace 370 may be configured to most closely match the users' desired experiences and workload needs, as defined within each users' xID. This matching is conducted via determination of a user experience compliance value from the xIDs of a user composite peripheral device workspace identifier by execution of code instructions of code instructions of a compliance-adjusted automatic node configuration module at servers of a peripheral device workspace cloud orchestrator 380 according to embodiments herein.

When the user information handling system 330 transfers to the new peripheral device workspace 370 (for example, from the first peripheral device workspace 250 described with reference to FIG. 2), the user information handling system 330 or a smart peripheral device (not shown) acting as the anchor node for the new peripheral device workspace 370 may transmit an updated peripheral device workspace anchor node status update document. The updated peripheral device workspace anchor node status update document may be transmitted to the ecosystem device management service 384 for execution of code instructions to store the same at the peripheral device workspace management system database 385. In an embodiment, the updated peripheral device workspace anchor node status update document may provide a user composite peripheral device workspace identifier for the user of the information handling system 330, a manifest of the information handling system 330 acting as the anchor node for the peripheral device workspace 370, a peripheral device workspace identification value for the peripheral device workspace 370, and identification of the new peripheral device secondary node 373 and any other secondary nodes in a manifest of nodes, along with a location indicator for the new peripheral device workspace 370, as well as various other peripheral device operational and environmental context telemetry readings, as described herein.

Code instructions for the compliance-adjusted automatic node configuration module may execute at the servers of the peripheral device workspace cloud orchestrator 380 in an embodiment to determine that a user for the anchor node information handling system has joined a new peripheral device workspace 370. For example, the compliance-adjusted automatic node configuration module 383 may monitor incoming peripheral device workspace anchor node status update documents to determine that a given user composite peripheral device workspace identifier for the user of the information handling system 330 that was been previously identified with a first or previous peripheral device workspace, such as 250 in FIG. 2, is now associated with a new peripheral device workspace identification value for the new peripheral device workspace 370. Upon determining that the user composite peripheral device workspace identifier has been associated with a new peripheral device workspace 370, the compliance-adjusted automatic node configuration module 383 may retrieve the most recently received peripheral device workspace anchor node status update document for the new peripheral device workspace and the user composite peripheral device workspace identifier from the peripheral device workspace management system database 385. As described herein, the peripheral device workspace anchor node status update document in embodiments may include a list of peripheral device functional capabilities for each of the peripheral device nodes, such as 373, listed within the manifest for the new peripheral device workspace 370.

The compliance-adjusted automatic node configuration module 383 may execute code instructions in an embodiment to retrieve one or more user experience fingerprints for the user of the information handling system 330 from her user composite peripheral device workspace identifier as well as associated peripheral device operational configuration policies for the user's other peripheral device workspaces, such as 250 from FIG. 2, from the peripheral device workspace management system database 385. As described herein, in order to configure a peripheral device node within a new peripheral device workspace 370 to most closely match each user's desired experiences from user experience fingerprints identified by xIDs, code instructions of the compliance-adjusted automatic node configuration module 385 may be executed to identify a peripheral device operational configuration policy confirmed to meet the user's desired experience for a peripheral device node, such as 251 or 254 in FIG. 2 within a user's previously established personalized peripheral device workspace, such as 250. First, the user's experience fingerprint for the desired experience with an existing peripheral device node must meet a user experiential compliance value threshold based on overlap of the new peripheral device node with the existing peripheral device node. When the user experiential compliance value threshold of overlap has been met, the peripheral device operational configuration policy confirmed to meet the user's desired experience for the existing peripheral device node may be applied to the same type of new peripheral device within the new peripheral device workspace 370 that the user has just joined. Meeting the user experiential compliance value threshold level of overlap occurs if the capabilities of the existing peripheral device, such as 251 or 254 in FIG. 2 within the user's previously established personalized peripheral device workspace 250 corresponds to or matches the capabilities of the peripheral device 373 within the new peripheral device workspace 370 with a sufficient level of overlap to meet the user experiential compliance value threshold. In embodiments, code instructions of the compliance-adjusted automatic node configuration module 383 may be executed to determine the user experiential compliance value that determines a percentage or ratio of overlap that compares the capabilities and configurations of the new peripheral device node 373 within the new peripheral device workspace 370 that the user of the information handling system 330 has recently joined with the capabilities and configurations of the peripheral devices 251 or 254 of FIG. 2 within the users' personalized previous peripheral device workspace 250 from previous user fingerprint data associated with one or more xIDs for a user.

For example, code instructions of the compliance-adjusted automatic node configuration module 383 may execute to identify any user xIDs and peripheral device workspace identification values associated with the user composite peripheral device workspace identifier given within one or more peripheral device workspace anchor node status update documents received for usage sessions by a user at another peripheral device workspace, such as 250 or 260 from FIG. 2. Some or all user experience fingerprints for the user of the information handling system 330 that are associated with the user xIDs may then be retrieved from the peripheral device workspace management system database 385 via execution of code instructions for the compliance-adjusted automatic node configuration module 383. Additionally, relevant peripheral device operational configuration policies for the user's other peripheral device workspaces, such as 250 in FIG. 2 that are associated with the identified peripheral device workspace identification values in the user composite peripheral device workspace identifier may also be retrieved from the peripheral device workspace management system database 385 through execution of code instructions for the compliance-adjusted automatic node configuration module 383 if overlap sufficient to meet a user experiential compliance value threshold is determined for one or more existing peripheral device nodes to apply to the new peripheral device node.

The user experience fingerprint and the peripheral device operation configuration policies so retrieved may both be associated with the user's composite peripheral device workspace identifier to identify the user's preferred experience in other peripheral device workspaces, such as 250, and configurations used previously to cause existing peripheral device nodes, such as 251 and 254 in FIG. 2, in those other previous peripheral device workspaces, such as 250, to operate to meet the user's preferred experience. For example, in an embodiment in which the new peripheral device secondary node 373 or another secondary node within the new peripheral device workspace 370 operates as an external video display, the compliance-adjusted automatic node configuration module 383 may retrieve a user experience fingerprint that identifies a previous peripheral device, such as 251 or 254 in FIG. 2, having a peripheral device functional capability of receiving video input in the high-definition multimedia interface (HDMI) 2.0 standard format if the new peripheral device node 373 is an HDMI 2.0 capable peripheral device and meets a user experiential compliance value threshold. As another example, in an embodiment in which the new peripheral device secondary node 373 or another secondary node within the new peripheral device workspace 370 operates as an external webcam, the compliance-adjusted automatic node configuration module 383 may retrieve a user experience fingerprint that identifies a previous peripheral device, such as 251 or 254 in FIG. 2, having a peripheral device functional capability of transmitting video output in the Universal Serial Bus (USB) 3.0 standard format when the new peripheral device 251 is capable of USB 3.0 video output transmission and meets the user experiential compliance value threshold. In yet another example, in an embodiment in which the new peripheral device secondary node 373 or another secondary node within the new peripheral device workspace 370 operates as an external speaker or headset, the compliance-adjusted automatic node configuration module 383 may retrieve a user experience fingerprint that identifies a previous peripheral device, such as 251 or 254 in FIG. 2, having a peripheral device functional capability of applying a noise-cancelling filter to outputted audio if the new peripheral device has noise cancelling and meets the user experiential compliance value threshold. In still another example, in an embodiment in which the new peripheral device secondary node 373 or another secondary node within the new peripheral device workspace 370 operates as an external webcam, the compliance-adjusted automatic node configuration module 383 may retrieve a user experience fingerprint that identifies a previous peripheral device, such as 251 or 254 in FIG. 2, having a peripheral device functional capability of applying an auto-framing video filter to outputted video if the same is available at the new peripheral device 373 and meets the user experiential compliance value threshold.

The peripheral device operational configuration policies retrieved may include configurations used previously to cause existing peripheral devices such as 251 and 254 in FIG. 2 in those other peripheral device workspaces, such as 250, to operate to meet the user's preferred experience, as described directly above with respect to the previous peripheral device functional capabilities. For example, in an embodiment in which the new peripheral device secondary node 373 or another secondary node within the new peripheral device workspace 370 operates as an external video display, the compliance-adjusted automatic node configuration module 383 may retrieve a peripheral device operational configuration policy configuring a previous peripheral device, such as 251 or 254 in FIG. 2 to display video at a resolution compliant with the 4K Ultra-high definition (UHD) standard, and at a refresh rate of 60 Hz. As another example, in an embodiment in which the new peripheral device secondary node 373 or another secondary node within the new peripheral device workspace 370 operates as an external webcam, the compliance-adjusted automatic node configuration module 383 may retrieve a peripheral device operational configuration policy configuring a previous peripheral device, such as 251 or 254 in FIG. 2 to record video in high definition (HD) resolution. In yet another example, in an embodiment in which the new peripheral device secondary node 373 or another secondary node within the new peripheral device workspace 370 operates as an external speaker or headset, the compliance-adjusted automatic node configuration module 383 may retrieve a peripheral device operational configuration policy configuring a previous peripheral device, such as 251 or 254 in FIG. 2 to turn on noise-cancellation audio filters. In still another example, in an embodiment in which the new peripheral device secondary node 373 or another secondary node within the new peripheral device workspace 370 operates as an external webcam, the compliance-adjusted automatic node configuration module 383 may retrieve a peripheral device operational configuration policy configuring a previous peripheral device, such as 251 or 254 in FIG. 2 to turn on auto-framing video filters.

Code instructions for the compliance-adjusted automatic node configuration module 383 in an embodiment may execute to generate an experience compliance value rating comparing the current or new peripheral device workspace 370 peripheral device functional capabilities to the user experience fingerprint and the previously instituted peripheral device operational configuration policies for the existing peripheral device node in a previous peripheral device workspace. As described herein, a peripheral device operational configuration policy for any one of the existing peripheral devices within the user's already established personalized peripheral device workspace or other previous peripheral device workspace, such as 250 in FIG. 2, may cause the code instructions for the compliance-adjusted automatic node configuration module 383 to generate a recommendation for application to corresponding new peripheral devices 373 within the new peripheral device workspace 370 when the user experiential compliance value meets a minimum threshold value to indicate a close match between the capabilities of the peripheral device 373 within the new peripheral device workspace 370 and the peripheral devices 251 or 254 of FIG. 2 within the user's previously established personalized peripheral device workspace 250. In other embodiments, the previously instituted peripheral device operational configuration policies for an existing peripheral device meeting the user experiential compliance value threshold may be automatically applied to a matching new peripheral device node 373. The determination of the user experiential compliance value in an embodiment may be repeated for each retrieved or identified peripheral device operational configuration policy and across plural new peripheral device nodes in a new peripheral device node workspace 370. For example, code instructions for the compliance-adjusted automatic node configuration module 383 may execute in an embodiment in which the new peripheral device workspace 370 includes an external display, an external webcam, and an external speaker or headset to generate the below Table 1 comparing the retrieved new peripheral device functional capabilities, previous peripheral device functional capabilities, and previous peripheral device operational configuration policies to generate an overall experience compliance rating for each new peripheral device node 373 and across the overall new peripheral device workspace 370.

TABLE 1

| | | Previous | | |
|---|---|---|---|---|
| | Previous | Peripheral | | |
| New Peripheral | Peripheral | device | Compliance of | |
| Device | Device | operational | Previous | |
| Functional | Functional | configuration | capabilities and | Experience |
| Capability | Capability | policy | policies with | Compliance |
| (Weight = 20%) | (Weight = 30%) | (Weight = 50%) | new capabilities | Rating |
| HDMI 2.0 | HDMI 2.0 | 4K UHD | Yes/Yes | 2 + 3 + 5 = 10 of 10 |
| | | Resolution; | | |
| | | 60 Hz Refresh | | |
| | | Rate | | |
| USB 2.0 | USB 3.0 | Video | No/No | 2 + 0 + 0 = 2 of 10 |
| | | Resolution: HD | | |
| Headset Noise | Headset Noise | Headset Noise | Yes/Yes | 2 + 3 + 5 = 10 of 10 |
| Cancellation | Cancellation | Cancellation: | | |
| | | ON | | |
| Webcam Auto- | Webcam Auto- | Webcam Auto- | Yes/Yes | 2 + 3 + 5 = 10 of 10 |
| Framing | Framing | Framing: ON | | |

| | |
|---|---|
| Overall Experience Compliance Rating | 10 + 2 + 10 + 10 = |
| | 32 of 40 = 80% |

As shown in Table 1, code instructions for the compliance-adjusted automatic node configuration module 383 in an embodiment may execute to determine, for each new peripheral device functional capability (e.g., each row of Table 1), whether the corresponding previous peripheral device functional capability or previous peripheral device operational configuration policy matches or is achievable by the new peripheral device functional capability. For example, code instructions for the compliance-adjusted automatic node configuration module 383 may execute to determine that the new peripheral device functional capability in row 2 of Table 1 of outputting video according to the HDMI 2.0 format standard matches the previous peripheral device functional capability of outputting video according to the HDMI 2.0 format standard and accommodates the previous peripheral device operational configuration policy requiring output of video at a resolution meeting the 4K UHD standard and at a refresh rate of 60 Hz. Consequently, row 2 of Table 1 may be assigned a Yes/Yes value for the compliance of previous capabilities and policies with new capabilities in the second column from the right of Table 1. As another example, code instructions for the compliance-adjusted automatic node configuration module 383 may execute to determine that the new peripheral device functional capability in row 3 of Table 1 of receiving video according to the USB 2.0 format standard, which does not support high-definition video does not match the previous peripheral device functional capability of receiving video according to the USB 3.0 format standard and does not accommodate the previous peripheral device operational configuration policy requiring input of video at a resolution meeting the HD standard. Consequently, row 3 of Table 1 may be assigned a No/No value for the compliance of previous capabilities and policies with new capabilities in the second column from the right of Table 1.

As yet another example, code instructions for the compliance-adjusted automatic node configuration module 383 may execute to determine that the new peripheral device functional capability in row 4 of Table 1 of applying a noise cancelling filter to incoming audio matches the previous peripheral device functional capability of applying a noise cancelling filter to incoming audio and accommodates the previous peripheral device operational configuration policy of turning on a noise cancellation audio filter. Consequently, row 4 of Table 1 may be assigned a Yes/Yes value for the compliance of previous capabilities and policies with new capabilities in the second column from the right of Table 1. In still another example, code instructions for the compliance-adjusted automatic node configuration module 383 may execute to determine that the new peripheral device functional capability in row 5 of Table 1 of applying an auto-framing video filter matches the previous peripheral device functional capability of applying an auto-framing video filter and accommodates the previous peripheral device operational configuration policy turning on an auto-framing video filter. Consequently, row 5 of Table 1 may be assigned a Yes/Yes value for the compliance of previous capabilities and policies with new capabilities in the second column from the right of Table 1.

Code instructions for the compliance-adjusted automatic node configuration module 383 in an embodiment may further determine, for each row of Table 1, an experience compliance rating describing compliance between the new peripheral device functional capability, the previous peripheral device functional capability, and the previous peripheral device operational configuration policy. In some cases, such as shown in Table 2, the importance of each of these capabilities and policies may be weighted for such a determination. For example, in Table 2, as shown in the top or first row, the new peripheral device capability may be weighted to 20%, the previous peripheral device capability may be weighted to 30%, and the previous peripheral device operational configuration policy may be weighted to 50%. It is contemplated that any weights may be applied to each of these three categories, so long as the percentages from each category sums together to equal 100%. As described with reference to FIG. 1, an information technology decision maker (ITDM) for an enterprise may enter these weighting values, for example, via a console for the peripheral device workspace cloud orchestrator 380.

The experience compliance rating for each row of Table 1 may be determined, via execution of code instructions for the compliance-adjusted automatic node configuration module 383, by assigning a weighted number based on the compliance values given in the second from right column of Table 1. Because the new peripheral device functional capability for each row, by definition, meets or matches itself, it is given a value of two, which is a weighted twenty percent of a 100% match. When a previous peripheral device functional capability matches the new peripheral device functional capability for a given row, as indicated by a first “yes” within the second from right column for that row, the previous peripheral device functional capability for that row may be given a value of three, which is a weighted thirty percent of a 100% match. When a previous peripheral device operational configuration policy matches or is compatible with the new peripheral device functional capability for a given row, as indicated by a second “yes” within the second from right column for that row, the previous peripheral device operational configuration policy for that row may be given a value of five, which is a weighted fifty percent of a 100% match. Any previous peripheral device functional capabilities or previous peripheral device operational configurations that do not match the new peripheral device functional capability for a given row, as indicated by a first or second “no” within the second from right column for that row will be assigned a value of zero.

For example, the new peripheral device functional capability of receiving video according to the HDMI 2.0 standard format in row 2 of Table 1 may provide a compliance rating of ten, which is equivalent to the weighted two for self-matching of the new peripheral device functional capability, plus the weighted three for matching of the previous peripheral device functional capability, plus the weighted five for matching of the previous peripheral device operational configuration policy. This same calculation may be made for rows 4 and 5 of Table 1, for applying a noise cancelling audio filter and applying an auto-framing video filter, respectively. In contrast, the new peripheral device functional capability of transmitting video according to the USB 2.0 standard format in row 3 of Table 1 may provide a compliance rating of two, which is equivalent to the weighted two for self-matching of the new peripheral device functional capability, plus zero for mis-matching of the previous peripheral device functional capability, plus zero for mis-matching of the previous peripheral device operational configuration policy. As shown in the bottom row of Table 1, code instructions for the compliance-adjusted automatic node configuration module 383 in an embodiment may then sum each of these experience compliance ratings in each row to provide an overall experience compliance rating of 32 out of a possible 40, or 80%.

It may be determined, through execution of code instructions for the compliance-adjusted automatic node configuration module, whether the overall experience compliance rating meets an overall user experiential compliance value threshold separately from the user experiential compliance value determined for each new peripheral device node. An experience compliance rating for a given functional capability may be lower if the functional capabilities for the new peripheral device 373 within the new peripheral device workspace 370 differs markedly from the functional capabilities of previous peripheral devices such as 251 or 254 within previously used peripheral device workspaces such as 250 of FIG. 2. For example, the new peripheral device 373 may have lower capabilities than the previously used peripheral device 251 or 254 from the previous peripheral device workspace 250, such as lower resolution for an external monitor or lack of high-definition video captures resolution for an external webcam. In such an embodiment, it may be inappropriate to configure the new peripheral device 373 in the same way that the previously used peripheral devices such as 251 or 254 within the previously used peripheral device workspace 250 were configured, because the new peripheral device 373 may not be capable of such a configuration.

In some cases, most of the peripheral device functional capabilities for the previously used peripheral devices such as 251 or 254 of FIG. 2 may be close or match the new peripheral device functional capabilities for the new peripheral device 373 within the new peripheral device workspace 370. In such an embodiment, it may be appropriate to consider configuring the new peripheral device 373 within the new peripheral device workspace 370 using peripheral device operational configuration policies for the previous peripheral devices 251 or 254 within the previous peripheral device workspace 250 of FIG. 2, as edited to accommodate any slight mismatches between the capabilities in the new peripheral device workspace 370 and the capabilities in the previously used peripheral device workspace 250. In other cases, there is a large disparity between the capabilities for the previously used peripheral devices such as 251 and 254 of FIG. 2 and the peripheral device functional capabilities for the new peripheral devices 373 within the new peripheral device workspace 370. This may occur, for example, if the new and previously used peripheral device workspaces 370 and 250, respectively contain different types of peripheral devices. In such embodiments, it may be inappropriate to configure the new peripheral device 373 in the same way that the previously used peripheral devices 251 or 254 within the previously used peripheral device workspace 250 of FIG. 2 were configured, as the user likely does not expect to use the new peripheral devices 373 in the same way that the previously used peripheral devices 251 or 254 were used.

In an embodiment in which the overall experience compliance rating does not meet an overall rating threshold value, code instructions for the compliance-adjusted automatic node configuration module may execute to generate one or more default peripheral device operational configuration policies for configuration of new peripheral device(s) in the new peripheral device workspace. For example, in an embodiment in which the ITDM has set a threshold value of 90% for the overall experience compliance rating, the calculated overall experience compliance rating of 80% shown in Table 1 above may fail to meet this threshold value. As described herein, failure of the overall experience compliance rating to meet the threshold value may indicate that the new and previously used peripheral device workspaces contain different types of peripheral devices or that the new peripheral device may have greater capabilities than the previously used peripheral device from the previous peripheral device workspace. In such a case, code instructions for the compliance-adjusted automatic node configuration module 383 may recommend that the workspace configuration recommendation service 382 recommend application of a default peripheral device operational configuration policy for the new peripheral device 373. The above overall user experiential compliance value threshold or user experiential compliance value thresholds for individual peripheral device nodes may be set at any of several levels of overlap. As described herein, settings for a given peripheral device, such as 373 may be set by the peripheral device workspace cloud manageability orchestrator module 380 to a default configuration determined based on identified capabilities of a given peripheral device. This default configuration may be stored as a peripheral device operational configuration policy within the peripheral device workspace management system database 385 and retrieved by the workspace configuration recommendation service 382 for transmission by the ecosystem device management service 384 to the anchor node 330 of the new peripheral device workspace 370 in an embodiment.

In an embodiment in which the overall experience compliance rating meets the threshold value set by the ITDM, code instructions for the compliance-adjusted automatic node configuration module 383 may execute to determine whether each of the individual peripheral devices, including 373 within the new peripheral device workspace 370 are capable of being configured according to the user's expectations for configuration of the previously used peripheral devices, such as 251 or 254 within the previously used peripheral device workspace 250 of FIG. 2. If the given new peripheral device 373 within the new peripheral device workspace 370 is capable of being configured according to the user's previously applied peripheral device operational configuration policies for a previously used peripheral device workspace, such as 250 in FIG. 2, then the new peripheral device 373 may be configured according to the previously applied peripheral device operational configuration policies without any further edits to those policies.

If a given new peripheral device 373 within the new peripheral device workspace 370 is not capable of being configured according to one or more adjustable configuration settings for the user's previously applied peripheral device operational configuration policies for a previously used peripheral device workspace, such as 250 in FIG. 2, then those one or more adjustable configuration settings may need to be edited to accommodate the new peripheral device 373 functional capabilities prior to application of the peripheral device operational configuration policy at the new peripheral device 373. For example, as shown in Table 1 at row three, the new peripheral device 373 operating as an external webcam may have a new peripheral device functional capability that includes receiving video signals via a USB 2.0 connection that is not capable of receiving high-definition video, which may be required by the retrieved peripheral device operational configuration, as shown in the middle column. In such a case, the compatibility-adjusted automatic node configuration module 383 may edit the retrieved peripheral device operational configuration policy used to populate the middle column to accommodate the limited peripheral device functional capability listed in the third row of Table 1. In other words, the compatibility-adjusted automatic node configuration module 383 may edit the retrieved peripheral device operational configuration policy such that the requirement for high-definition webcam signal is deleted or moved to a standard-definition webcam signal, as supported by a USB 2.0 connection. This edited peripheral device operational configuration policy may be stored within the peripheral device workspace management system database 385 and retrieved by the workspace configuration recommendation service 382 for transmission by the ecosystem device management service 384 to the anchor node 330 of the new peripheral device workspace 370 in an embodiment.

Code instructions for the compliance-adjusted automatic node configuration module 383 in an embodiment may execute to transmit the default, edited, or unedited peripheral device operational configuration policy to the new peripheral device workspace anchor node 330 for institution within the new peripheral device workspace 370. In such a way, the new peripheral device 373 within the new peripheral device workspace 370 may be configured to most closely match the users' desired experiences and workload needs, as defined within each user's xID, and to match the configurations of previously used peripheral devices, such as 251 or 254 in previously used peripheral device workspaces such as 250 in FIG. 2, having similar capabilities to those of the new peripheral device workspace 370.

FIG. 3B is a block diagram illustrating a collaborative peripheral device node in a collaborative peripheral device workspace interfacing with a peripheral device workspace cloud orchestrator server to be automatically configured to accommodate the capabilities of each of a plurality of information handling systems operatively coupled to the collaborative peripheral device node according to an embodiment of the present disclosure. As described previously, in the case where multiple users of multiple information handling systems 330 and 361 are simultaneously sharing or are operatively coupled to the same collaboration peripheral device 365, such as a conference room projector, it may be desirable to configure the collaboration peripheral device 365 in a way that each of the operatively coupled users' information handling systems 330 and 361 may accommodate interacting with it in a similar fashion. For example, a conference room projector may be capable of display according to a plurality of resolutions, including a 3840×2160 pixel 4K ultra high definition (4K UHD) resolution. However, not all user information handling systems operatively coupled to the conference room projector 365 at a given time may be capable of output from their information handling systems, such as 330 or 361, to the conference room projector 365 in 4K UHD resolution. One of the plurality of information handling systems, such as 361 may be only capable of output having a highest possible resolution of sub-high definition 1920×1080 pixels. In such a case, it may be desirable to configure the collaboration peripheral device 365 (e.g., conference room projector) to display at the 1920×1080 pixel resolution at which at least all of the users' information handling systems 330 and 361 currently operatively coupled to the collaboration peripheral device 365 are compatible and able to operate without distortion or reduction in user experience.

When the user information handling system 330 transfers to the collaborative peripheral device workspace 360 (from the first peripheral device workspace 250 described with reference to FIG. 2), the user information handling system 330 or a smart peripheral device (not shown) acting as the anchor node for the collaborative peripheral device workspace 360 may transmit an updated peripheral device workspace anchor node status update document. The updated peripheral device workspace anchor node status update document may be transmitted to the ecosystem device management service 384 for storage at the peripheral device workspace management system database 385. In an embodiment, the updated peripheral device workspace anchor node status update document may provide a user composite peripheral device workspace identifier for the user of the information handling system 330, a user composite peripheral device workspace identifier for the user of the information handling system 361, a manifest of nodes including the information handling system 330 acting as the anchor node for the collaborative peripheral device workspace 360, a peripheral device workspace identification value for the collaborative peripheral device workspace 360, and identification of the collaborative peripheral device secondary node 365 and other secondary nodes in the manifest of nodes, along with a location indicator, as well as various other peripheral device operational and environmental context telemetry readings, as described herein.

Code instructions for the compliance-adjusted automatic node configuration module 383 may execute in an embodiment to determine that a user for the anchor node information handling system 330 has joined a collaborative peripheral device workspace 360. For example, the compliance-adjusted automatic node configuration module 383 may monitor incoming peripheral device workspace anchor node status update documents to determine that a plurality of user composite peripheral device workspace identifiers are associated with a single peripheral device workspace identification value for the collaborative peripheral device workspace 370 at an identified location. This may indicate that the recently joined peripheral device workspace is a collaborative peripheral device workspace 370, and allows multiple information handling systems 330 and 361 to simultaneously operatively couple with a single collaborative peripheral device node 365.

In order to provide the same user experience to each of the user information handling systems within the detected collaborative peripheral device workspace, code instructions for the compliance-adjusted automatic node configuration module 383 may execute to configure the collaborative peripheral device 365, such as the conference room projector, for use by all coupled users' information handling systems 330 and 361 simultaneously. This may involve determining one or more configurations for the collaborative peripheral device 365 with which the capabilities of each of the user anchor information handling systems 330 and 361 within the collaborative peripheral device workspace 360 are compatible. In other words, a lowest (or highest) common configuration setting each of the user anchor information handling systems 330 and 361 may be selected so no particular user has compatibility issues and all users can reach a sufficient level of experience with the collaborative peripheral device 365. To this end, code instructions of the compliance-adjusted automatic node configuration module 383 may execute to identify one configurations or settings for the collaborative peripheral device 365 that each of the collaborating user information handling systems 330 and 361 can accommodate.

Upon determining that the user composite peripheral device workspace identifier has been associated with a collaborative peripheral device workspace 360, the compliance-adjusted automatic node configuration module 383 may retrieve the most recently received peripheral device workspace anchor node status update document for the user composite peripheral device workspace identifier from the peripheral device workspace management system database 385. As described herein, the peripheral device workspace anchor node status update document in embodiments may include a list of peripheral device functional capabilities for each of the collaborative or other peripheral devices, such as 365, listed within the manifest for the collaborative peripheral device workspace 360. For example, the peripheral device workspace anchor node status update document in an embodiment may include a list of peripheral device functional capabilities for a collaborative peripheral device 365 that is a common video display device, such as a video output resolution and refresh rate. More specifically, the peripheral device workspace anchor node status update document may include a peripheral device functional capability for the collaborative peripheral device 365 of 3840×2160 pixel 4K ultra high definition (4K UHD) video output resolution. As another example, the peripheral device workspace anchor node status update document may include a peripheral device functional capability for the collaborative peripheral device 365 of a 60 Hz video output refresh rate.

The peripheral device workspace anchor node status update document in an embodiment may also include a list of functional capabilities for each of the information handling systems 361 and 330, listed within the manifest for the collaborative peripheral device workspace 360. For example, the peripheral device workspace anchor node status update document in an embodiment may include a list of information handling system functional capabilities, such as a video output resolution and refresh rate. More specifically, the peripheral device workspace anchor node status update document may include a functional capability for the information handling system 330 of 1920×1080 video output resolution, and a functional capability for the information handling system 361 of 1366×768. As another example, the peripheral device workspace anchor node status update document may include a functional capability for the information handling system 330 of a 60 Hz video output refresh rate and a functional capability for the information handling system 361 of a 60 Hz video output refresh rate.

Code instructions for the compliance-adjusted automatic node configuration module 383 in an embodiment may then execute to determine a minimum functional capability that can be achieved by each of the information handling systems 330 and 361 operatively coupled to the collaborative peripheral device 365 and the collaborative peripheral device 365 itself. For example, the compliance-adjusted automatic node configuration module 383 in an embodiment may determine that the information handling system 361 is associated with a minimum or lowest quality video resolution of 1366×768 pixels that can also be accommodated by the information handling system 330 as well as the collaborative peripheral device 365. As another example, the compliance-adjusted automatic node configuration module 383 in an embodiment may determine that the information handling system 361 and information handling system 330 can accommodate the same refresh rate of 60 Hz as the collaborative peripheral device 365.

Code instructions of the compliance-adjusted automatic node configuration module 383 may execute in an embodiment to generate a peripheral device operational configuration policy for the collaborative peripheral device 365 that includes the minimum functional capability achievable by the collaborative peripheral device 365 and each of the operatively coupled information handling systems 330 and 361. For example, the compliance-adjusted automatic node configuration module 383 in an embodiment may generate a peripheral device operational configuration policy that includes a setting for a video resolution of 1366×768 pixels that can be accommodated by the information handling systems 330 and 361 and the collaborative peripheral device 365. As another example, the compliance-adjusted automatic node configuration module 383 in an embodiment may generate a peripheral device operational configuration policy that includes a setting for a video refresh rate of 60 Hz that can be accommodated by the information handling systems 330 and 361 and the collaborative peripheral device 365.

The compatibility-adjusted automatic node configuration module 383 may store the generated peripheral device operational configuration policy described directly above within the peripheral device workspace management system database 385. The workspace configuration recommendation service 382 may then retrieve this peripheral device operational configuration policy for transmission by the ecosystem device management service 384 to the anchor node 330 of the new peripheral device workspace 370 in an embodiment. In such a way, execution of code instructions of the compliance-adjusted automatic node configuration module 383 may automatically configure collaborative peripheral devices 365, such as conference room projector or common video display device, for use by all collaborating and operatively coupled user information handling systems 330 and 361.

FIG. 4 is a flow diagram illustrating a method of automatically configuring one or more new peripheral device nodes, such as within a new peripheral device workspace, to most closely match a user's desired experience and expected workload based on configurations of other existing peripheral device nodes to which the user's information handling system has been operatively coupled in previously used peripheral device workspaces according to an embodiment of the present disclosure. As described herein, when users shift from a personalized, previous peripheral device workspace to a new peripheral device workspace, there is often a mismatch between the capabilities for the peripheral devices within the new peripheral device workspace and the capabilities or configurations for the peripheral devices within the users' personalized peripheral device workspaces. A cloud-based server executing code instructions of the compliance-adjusted automatic node configuration module in embodiments herein may leverage the user experience fingerprints for each of such users to more accurately match the capabilities and configurations of the new peripheral device nodes within the new peripheral device workspace with the capabilities and configurations of the existing peripheral device nodes within the users' personalized peripheral device workspaces for usage sessions reflected in those user experience fingerprints at other peripheral device workspaces. In such a way, the new peripheral devices within the new peripheral device workspace may be configured to most closely match the users' desired experiences and workload needs, as defined within each user's xID for those previous usage sessions of the existing peripheral device node that meet a user experiential compliance value threshold with the new peripheral device node.

In order to configure a peripheral device within a new peripheral device workspace to most closely match each user's desired experiences, code instructions of the compliance-adjusted automatic node configuration module may be executed to identify a peripheral device operational configuration policy confirmed to meet the user's desired experience for an existing peripheral device node within a user's previously established personalized peripheral device workspace. The existing peripheral device node must have a user experiential compliance value that overlaps the new peripheral device node to a sufficient level to meet an user experiential compliance value threshold. When such an overlap match is met, the peripheral device operational configuration policy confirmed to meet the user's desired experience for the existing peripheral device node may be applied to the same type of peripheral device within the new peripheral device workspace that the user has just joined. However, this may only be possible if the capabilities of the existing peripheral device within the user's previously established personalized peripheral device workspace correspond to or sufficiently overlap the capabilities of the peripheral device within the new peripheral device workspace for the user experiential compliance value threshold to be met. In embodiments, code instructions of the compliance-adjusted automatic node configuration module may be executed to determine a user experiential compliance value that compares the capabilities and configurations of the new peripheral devices within the new peripheral device workspace the user has recently joined with the capabilities and configurations of the existing peripheral devices within the users' personalized peripheral device workspaces from user experience fingerprints identified by an xID in an user composite peripheral device workspace identifier for a user.

At block 402, a peripheral device workspace anchor node user information handling system may collect and transmit to a cloud manageability orchestrator module a peripheral device workspace anchor node status update document including a manifest of peripheral devices in the peripheral device workspace for each peripheral device workspace within an enterprise. This may include a list of existing functional capabilities for each node in each of the existing peripheral device workspaces, where and when communication and retrieval of such environmental context telemetry is available. For example, as described in an embodiment with respect to FIG. 1, peripheral device operational and environmental context telemetry readings gathered pursuant to execution of code instructions for an ecosystem manageability sub-agent 172 in an embodiment may include, for example, information specific to the information handling system 100, or the operative connection between the information handling system 100 and the peripheral devices 142, when in one or another peripheral device workspace. More specifically, the peripheral device operational and environmental context telemetry readings gathered pursuant to execution of code instructions for the ecosystem manageability sub-agent may include, for the information handling system 100, a current power mode (e.g., sleep mode, battery mode, operational mode, powered down), range of possible power modes, current time, geographic location for the peripheral device workspace that includes the information handling system 100, current execution of a specific software application, hardware processor 102 or 104 utilization rate, memory 106, 108, or 120 utilization rate, remaining battery power for battery 124.

In another example embodiment described with respect to FIG. 2, code instructions for the ecosystem manageability sub-agent 290 in an embodiment may execute to gather, via an ecosystem manageability interface 252 at one or more secondary node peripheral devices, various peripheral device operational and environmental context telemetry readings describing operational capabilities for the one or more secondary node peripheral devices such as 251 within the peripheral device workspace 250. For example, the code instructions for the ecosystem manageability sub-agent 290 operating at the anchor node 230 may execute to gather peripheral device operational and environmental context telemetry readings regarding the range of capabilities for each peripheral device (e.g., 251 and 254). The information defining the range of functional capabilities for the peripheral device 251 may be stored at the peripheral device 251, within the firmware 253, or in a device descriptor (ODD) service 292. In an embodiment, the ODD service 292 the peripheral device 251 may also store static or non-adjustable features for the peripheral device 251, such as locations for various ports, physical dimensions of the new peripheral device 251, or physical locations for internal components such as an embedded camera. Model number, device number, media access control (MAC) address, or other identifying information for the peripheral device 251 may also be stored within the ODD service 292, while similar identifying information for the peripheral device 251 in an embodiment may be stored within firmware 253. The ecosystem manageability sub-agent 290 of the anchor node information handling system 230 may execute code instructions in an embodiment to retrieve the functional capabilities for the peripheral device 251 from the firmware 253 via communication with the ecosystem manageability interface 252, which may act as an application programming interface (API), for example, between the firmware 253 and the ecosystem manageability sub-agent 290. The ODD may include a unique peripheral device identification as well as an environmental telemetry data set describing the peripheral device operational and environmental context telemetry readings regarding the range of capabilities for each peripheral device (e.g., 251 and 254).

The peripheral device workspace anchor node in an embodiment may generate and transmit to the cloud manageability orchestrator module a peripheral device workspace anchor node status update document including manifest of peripheral devices in peripheral device workspace and collected peripheral device operation and environmental context telemetry readings for a peripheral device workspace location identified by a location identifier. For example, in an embodiment described with respect to FIG. 1, code instructions for the ecosystem manageability sub-agent 172 executing at the information handling system 100 in a peripheral device workspace may create a manifest of peripheral device nodes 142 and other nodes for a peripheral device workspace identification value to represent the current peripheral device workspace, including an identification of the user, and an identification (e.g., by product serial number or other peripheral device identification) of each of the peripheral device nodes 142 connected to or operably coupled to the anchor information handling system 100 at a peripheral device workspace.

The hardware processor 102 of the user anchor information handling system 100 may execute code instructions of the ecosystem manageability sub-agent 172 to also collect one or more peripheral device operational and environmental context telemetry readings (e.g., time, applications executing, hardware component usage metrics, or other telemetry data indicating usage patterns for the information handling system 100 or various peripheral devices 142 in a peripheral device workspace). The manifest of peripheral device nodes and other nodes as well as location of a peripheral device workspace described above may be combined with the peripheral device operational and environmental context telemetry readings for the peripheral device workspace and an identification of the anchor node information handling system 100 user into a peripheral device workspace anchor node status update document written in a machine-readable language or machine markup language such as JavaScript Object Notation (JSON), for example, to be associated with a peripheral device workspace identification value.

This peripheral device workspace anchor node status update document is transmitted for storage with the peripheral device workspace identification value at a peripheral device workspace management system database 167 operating in the peripheral device workspace cloud orchestrator 156. Each time a peripheral device configuration setting is changed by the user, a new peripheral device is added to the peripheral device workspace, the peripheral device workspace anchor node information handling system moves to a new peripheral device workspace, or changes to environmental context data for the peripheral device workspace are detected, a new peripheral device workspace anchor node status update document including this updated configuration may be transmitted to the peripheral device workspace cloud orchestrator 156 for association with the peripheral device workspace identification value for the peripheral device workspace. Additionally, values for the ODD of each peripheral device in the manifest of peripheral devices in the peripheral device workspace may also be updated with these changes. Similarly, a given set of configuration settings operated by a user for a period of time, such as a usage session, may establish an xID for the user's user composite peripheral device workspace identifier to record usages of the peripheral devices by a user in a peripheral device workspace.

As another example described with reference to FIG. 2, each time the peripheral device workspace anchor node information handling system 230 moves to a new peripheral device workspace, such as 260 or 270, a new peripheral device workspace anchor node status update document may be transmitted to the peripheral device workspace cloud orchestrator 280 for association with the peripheral device workspace identification value for the new peripheral device workspace 260 or 270 within storage at the peripheral device workspace management system database 285. More specifically, and as described in an embodiment with reference to FIG. 3A, when the user information handling system 330 transfers to the new peripheral device workspace 370 (from the first peripheral device workspace such as 250 described with reference to FIG. 2), the user information handling system 330 or a smart peripheral device (not shown) acting as the anchor node for the new peripheral device workspace 370 may transmit an updated peripheral device workspace anchor node status update document. The updated peripheral device workspace anchor node status update document may be transmitted to the ecosystem device management service 384 for storage at the peripheral device workspace management system database 385.

Code instructions for the compliance-adjusted automatic node configuration module may execute in an embodiment at block 404 to determine that a user for the anchor node information handling system has joined a new peripheral device workspace. For example, the compliance-adjusted automatic node configuration module 383 may monitor incoming peripheral device workspace anchor node status update documents to determine that a given user composite peripheral device workspace identifier for the user of the information handling system 330 that has been previously identified with a first or previous peripheral device workspace, such as 250 in FIG. 2, is now associated with a new peripheral device workspace identifier for the new peripheral device workspace 370 at a different location.

At block 406, code instructions for the compliance-adjusted automatic node configuration module may execute to retrieve a list of peripheral device functional capabilities for each of the peripheral devices listed within the manifest for the new peripheral device workspace from the peripheral device workspace management system database as determined from telemetry data from the anchor information handling system. Upon determining that the user composite peripheral device workspace identifier has been associated with a new peripheral device workspace 370, the compliance-adjusted automatic node configuration module 370 may retrieve the most recently received peripheral device workspace anchor node status update document for the user composite peripheral device workspace identifier from the peripheral device workspace management system database 385. As described herein, the peripheral device workspace anchor node status update document in embodiments may include a list of peripheral device functional capabilities for each of the new peripheral devices, such as 373, listed within the manifest for the new peripheral device workspace 370.

In an embodiment at block 408, code instructions for the compliance-adjusted automatic node configuration module may execute to retrieve a user experience fingerprint for the user and peripheral device operational configuration policies for the user's other peripheral device workspaces from the peripheral device workspace management system database. For example, the compliance-adjusted automatic node configuration module 383 may execute code instructions in an embodiment to retrieve a user experience fingerprint for the user of the information handling system 330 and peripheral device operational configuration policies for the user's other peripheral device workspaces, such as 250 from FIG. 2 from the peripheral device workspace management system database 385. More specifically, code instructions of the compliance-adjusted automatic node configuration module 383 may execute to identify any user xIDs and peripheral device workspace identification values associated with the user composite peripheral device workspace identifier given within the most recently received peripheral device workspace anchor node status update document. All user experience fingerprints for the user of the information handling system 330 that are associated with the user xIDs may then be retrieved from the peripheral device workspace management system database 385 via execution of code instructions for the compliance-adjusted automatic node configuration module 383. Additionally, all peripheral device operational configuration policies for the user's other peripheral device workspaces, such as 250 in FIG. 2 that are associated with the identified peripheral device workspace identification values associated with the user composite peripheral device workspace identifier may also be retrieved from the peripheral device workspace management system database 385 through execution of code instructions for the compliance-adjusted automatic node configuration module 383.

As described herein referencing FIG. 3, in order to configure a new peripheral device 373 within a new peripheral device workspace 370 to most closely match each user's desired experiences, code instructions of the compliance-adjusted automatic node configuration module 385 may be executed to identify a peripheral device operational configuration policy confirmed to meet the user's desired experience for a peripheral device, such as 251 or 254 in FIG. 2, within a user's previously established personalized peripheral device workspace, such as 250, that may be applied to the same type of peripheral device within the new peripheral device workspace 370 that the user has just joined. However, this may only be possible if the capabilities of the peripheral device, such as 251 or 254 in FIG. 2 within the user's previously established personalized peripheral device workspace 250 correspond to or match the capabilities of the peripheral device 373 within the new peripheral device workspace 370. In embodiments, code instructions of the compliance-adjusted automatic node configuration module 383 may be executed to determine a user experiential compliance value that compares the capabilities and configurations of the new peripheral device 373 within the new peripheral device workspace 370 that the user of the information handling system 330 has recently joined with the capabilities and configurations of the existing peripheral devices, such as 251 or 254 of FIG. 2, within the users' personalized previous peripheral device workspace, such as 250, as determined from the user experience fingerprint or fingerprints from that personalized previous peripheral device workspace.

The user experience fingerprint and the peripheral device operation configuration policies so retrieved may both be associated with the user's composite peripheral device workspace identifier to identify the user's preferred experience in other peripheral device workspaces, such as 250, and configurations used previously to cause peripheral devices such as 251 and 254 in FIG. 2 in those other peripheral device workspaces, such as 250, to operate to meet the user's preferred experience. For example, in an embodiment in which the new peripheral device secondary node 373 or another secondary node within the new peripheral device workspace 370 operates as an external video display, the compliance-adjusted automatic node configuration module 383 may retrieve a user experience fingerprint that identifies a previous peripheral device, such as 251 or 254 in FIG. 2, as an external video display having a peripheral device functional capability of receiving video input in the high-definition multimedia interface (HDMI) 2.0 standard format. As another example, in an embodiment in which the new peripheral device secondary node 373 or another secondary node within the new peripheral device workspace 370 operates as an external webcam, the compliance-adjusted automatic node configuration module 383 may retrieve a user experience fingerprint that identifies a previous peripheral device, such as 251 or 254 in FIG. 2, having a peripheral device functional capability of transmitting video output in the Universal Serial Bus (USB) 3.0 standard format. In yet another example, in an embodiment in which the new peripheral device secondary node 373 or another secondary node within the new peripheral device workspace 370 operates as an external speaker or headset, the compliance-adjusted automatic node configuration module 383 may retrieve a user experience fingerprint that identifies a previous peripheral device, such as 251 or 254 in FIG. 2, having a peripheral device functional capability of applying a noise-cancelling filter to outputted audio. In still another example, in an embodiment in which the new peripheral device secondary node 373 or another secondary node within the new peripheral device workspace 370 operates as an external webcam, the compliance-adjusted automatic node configuration module 383 may retrieve a user experience fingerprint that identifies a previous peripheral device, such as 251 or 254 in FIG. 2, having a peripheral device functional capability of applying an auto-framing video filter to outputted video.

The peripheral device operational configuration policies retrieved may include configurations used previously to cause existing peripheral devices, such as 251 and 254 in FIG. 2, in those other peripheral device workspaces, such as 250, to operate to meet the user's preferred experience, as described directly above with respect to the previous peripheral device functional capabilities. For example, in an embodiment in which the new peripheral device secondary node 373 or another secondary node within the new peripheral device workspace 370 operates as an external video display, the compliance-adjusted automatic node configuration module 383 may retrieve a peripheral device operational configuration policy configuring a previous peripheral device, such as 251 or 254 in FIG. 2, to display video at a resolution compliant with the 4K Ultra-high definition (UHD) standard and at a refresh rate of 60 Hz. As another example, in an embodiment in which the new peripheral device secondary node 373 or another secondary node within the new peripheral device workspace 370 operates as an external webcam, the compliance-adjusted automatic node configuration module 383 may retrieve a peripheral device operational configuration policy configuring a previous peripheral device, such as 251 or 254 in FIG. 2, to record video in high definition (HD) resolution. In yet another example, in an embodiment in which the new peripheral device secondary node 373 or another secondary node within the new peripheral device workspace 370 operates as an external speaker or headset, the compliance-adjusted automatic node configuration module 383 may retrieve a peripheral device operational configuration policy configuring a previous peripheral device, such as 251 or 254 in FIG. 2, to turn on noise-cancellation audio filters. In still another example, in an embodiment in which the new peripheral device secondary node 373 or another secondary node within the new peripheral device workspace 370 operates as an external webcam, the compliance-adjusted automatic node configuration module 383 may retrieve a peripheral device operational configuration policy configuring a previous peripheral device, such as 251 or 254 in FIG. 2, to turn on auto-framing video filters.

At block 410, code instructions for the compliance-adjusted automatic node configuration module in an embodiment may execute to generate a user experience compliance rating that is a user experiential compliance value that represents overlap of peripheral device nodes from comparing the current, new peripheral device workspace peripheral device functional capabilities to the previously instituted peripheral device operational configuration policies for an existing peripheral device node from the user experience fingerprint of a user. For example, code instructions for the compliance-adjusted automatic node configuration module 383 may execute in an embodiment in which the new peripheral device workspace 370 includes an external display, an external webcam, and an external speaker or headset to generate Table 1 above comparing the retrieved new peripheral device functional capabilities, previous peripheral device functional capabilities, and previous peripheral device operational configuration policies from one or more previous peripheral device nodes to generate an user experiential compliance value for each type of peripheral device node to meet a user experiential compliance value threshold indicating sufficient overlap of the peripheral devices. Further, an overall experience compliance rating of the user experiential compliance values may be determined for the plural peripheral device nodes in the peripheral device workspaces being compared.

As shown in Table 1, code instructions for the compliance-adjusted automatic node configuration module 383 in an embodiment may execute to determine, for each new peripheral device functional capability (e.g., each row of Table 1), whether the corresponding previous peripheral device functional capability or previous peripheral device operational configuration policy matches or is achievable by the new peripheral device functional capability of a new peripheral device node as compared to an existing peripheral device node. Each row of Table 1 in which the previous peripheral device functional capability matches the new peripheral device functional capability may be assigned a first Yes value in the second column from the right of Table 1. Each row of Table 1 in which the previous peripheral device operational configuration matches the new peripheral device functional capability may be assigned a second Yes value in the second column from the right of Table 1.

Code instructions for the compliance-adjusted automatic node configuration module 383 in an embodiment may further determine, for each row of Table 1, an experience compliance rating describing compliance between the new peripheral device functional capability, the previous peripheral device functional capability, and the previous peripheral device operational configuration policy indicating whether each may meet a set user experiential compliance value threshold. The experience compliance rating for each row of Table 1 may be determined, via execution of code instructions for the compliance-adjusted automatic node configuration module 383, by assigning a weighted number based on the compliance values given in the second from right column of Table 1 and may represent an indication of overlap levels of features, configurations, capabilities, or settings for peripheral device nodes being compared. For example, the new peripheral device functional capability of receiving video according to the HDMI 2.0 standard format in row 2 of Table 1 may provide a compliance rating of ten, which is equivalent to the weighted two for self-matching of the new peripheral device functional capability, plus the weighted three for matching of the previous peripheral device functional capability, plus the weighted five for matching of the previous peripheral device operational configuration policy. This same calculation may be made for rows 4 and 5 of Table 1, for applying a noise cancelling audio filter and applying an auto-framing video filter, respectively. In contrast, the new peripheral device functional capability of transmitting video according to the USB 2.0 standard format in row 3 of Table 1 may provide a compliance rating of two, which is equivalent to the weighted two for self-matching of the new peripheral device functional capability, plus zero for mis-matching of the previous peripheral device functional capability, plus zero for mis-matching of the previous peripheral device operational configuration policy. In an additional step of determining overlap compliance for one or more compared peripheral device nodes in some embodiments, the peripheral device workspaces in which the compared new peripheral device node and the existing peripheral device node may be compared for overall user experiential compliance value meeting a threshold. As shown in the bottom row of Table 1, code instructions for the compliance-adjusted automatic node configuration module 383 in an embodiment may then sum each of these experience compliance ratings in each row to provide an overall experience compliance rating of 32 out of a possible 40, or 80% for the previous peripheral device workspace compared to a new peripheral device workspace.

It may be determined at block 412, through execution of code instructions for the compliance-adjusted automatic node configuration module, whether an overall experience compliance rating generated at block 410 meets an overall user experiential compliance value threshold. The overall experience compliance rating or overall user experiential compliance value in an embodiment may be a sum of the experience compliance ratings or sum of user experiential compliance values for each of the functional capabilities for each of the peripheral devices within the new peripheral device workspace as compared to a previous peripheral device workspace. An experience compliance rating for a given functional capability may be lower if the functional capabilities for the new peripheral device within the new peripheral device workspace differs markedly from the functional capabilities of peripheral devices within previously used peripheral device workspaces. For example, one or more new peripheral devices may have greater capabilities than the one or more previously used peripheral devices from the previous peripheral device workspace, such as higher resolution for an external monitor or high-definition video captures resolution for an external webcam. Use of these peripheral device nodes together in a respective peripheral device workspace may have substantial performance effects and thus comparison of peripheral device workspaces is needed in some embodiments. In such an embodiment, it may be inappropriate to configure the new peripheral device from a new peripheral device workspace in the same way that the previously used peripheral devices within the previously used peripheral device workspace were configured when an overall user experiential compliance value threshold for the compared peripheral device workspaces is not met, because it may inadvertently cause degraded user experience of the new peripheral device that has higher capabilities than the previously used peripheral device.

In some cases, most of the peripheral device functional capabilities for the previously used peripheral devices may be close enough or match the peripheral device functional capabilities for the new peripheral devices within the new peripheral device workspace to meet an overall user experiential compliance value threshold. In such an embodiment, it may be appropriate to consider configuring the new peripheral devices within the new peripheral device workspace using peripheral device operational configuration policies for the previous peripheral devices within the previous peripheral device workspace, as edited to accommodate any slight mismatches between the capabilities in the new peripheral device workspace and the capabilities in the previously used peripheral device workspace. In other cases, there is a large disparity between the capabilities for the previously used peripheral devices and the peripheral device functional capabilities for the new peripheral devices within the new peripheral device workspace. This may occur, for example, if the new and previously used peripheral device workspaces contain different types of peripheral devices. In such embodiments, as described directly above, it may be inappropriate to configure the one or more new peripheral devices in the same way that the previously used peripheral devices within the previously used peripheral device workspace were configured, as the user likely does not expect to use the new peripheral devices in the same way that the previously used peripheral devices were used.

If the overall experience compliance rating generated at block 410 meets an overall user experiential compliance value threshold, this may indicate that most of the peripheral device functional capabilities for the previously used peripheral devices may be close or match the peripheral device functional capabilities for the new peripheral devices within the new peripheral device workspace to meet a user experiential compliance value threshold for each comparison of a new peripheral device node with an existing peripheral device node between the new and previous peripheral device workspaces. In such a case, the method may proceed to block 416 for determination as to whether the peripheral device operational configuration for the previous peripheral device workspace needs to be edited to accommodate any slight mismatches between the capabilities in the new peripheral device workspace and the capabilities in the previously used peripheral device workspace. If the overall experience compliance rating generated at block 410 does not meet a threshold value, this may indicate that the new and previously used peripheral device workspaces contain some substantially different types of peripheral device nodes or that the new peripheral device may have greater or lesser capabilities than the previously used peripheral device from the previous peripheral device workspace. In such a scenario, the user may likely not wish to use the new peripheral device workspace in the same way that they used the previously used peripheral device workspace, and the method may proceed to block 414 for configuration of the new peripheral device workspace without consideration of how the previously used peripheral device workspace was configured.

At block 414, in an embodiment in which the overall experience compliance rating does not meet an overall rating threshold value, code instructions for the compliance-adjusted automatic node configuration module may execute to generate one or more default peripheral device operational configuration policies for configuration of new peripheral device(s) in the new peripheral device workspace. For example, in an embodiment described with reference to FIG. 3A in which the ITDM has set an overall user experiential compliance value threshold of 90% for the overall experience compliance rating, the calculated overall experience compliance rating of 80% shown in Table 1 above may fail to meet this threshold value. Any overall user experiential compliance value threshold value may be used in various embodiments. As described herein, failure of the overall experience compliance rating to meet the overall user experiential compliance value threshold may indicate that the new and previously used peripheral device workspaces contain substantially different types of peripheral devices or that the new peripheral device may have greater or lesser capabilities than the previously used peripheral device from the previous peripheral device workspace. This may cause review of a different previous peripheral device workspace from the user composite peripheral device workspace identifier for a user to see if a better fit is available. If not, code instructions for the compliance-adjusted automatic node configuration module 383 may generate a recommendation that the workspace configuration recommendation service 382 apply a default peripheral device operational configuration policy for the new peripheral device 373. As described herein, settings for a given peripheral device, such as 373 may be set by the peripheral device workspace cloud manageability orchestrator module 380 to a default configuration determined based on identified capabilities of a given peripheral device. This default configuration may be stored as a peripheral device operational configuration policy within the peripheral device workspace management system database 385. The method may then proceed to block 420 for transmission of the default peripheral device operational configuration policies to the new peripheral device workspace anchor node for application after which the method may end.

In an embodiment in which the overall experience compliance rating meets the overall user experiential compliance value threshold, code instructions for the compliance-adjusted automatic node configuration module may execute at block 416 to determine whether each of the individual peripheral devices within the new peripheral device workspace are capable of being configured according to the user's expectations for configuration of the previously used peripheral devices within the previously used peripheral device workspace. This may be determined with a calculation of overlap represented by if comparison of a new peripheral device node and an existing peripheral device node meet a user experiential compliance value threshold value for those nodes, as in ranges of settings or configurations overlap such that the new peripheral device node may be adjusted to the previous peripheral device node settings. If a given new peripheral device within the new peripheral device workspace is capable of being configured according to the user's previously applied peripheral device operational configuration policies for a previously used peripheral device workspace, then the new peripheral device may be configured according to the previously applied peripheral device operational configuration policies without any further edits to those policies, and the method may proceed to block 420. If a given new peripheral device within the new peripheral device workspace is not capable of being configured according to one or more adjustable configuration settings for the user's previously applied peripheral device operational configuration policies for a previously used peripheral device workspace, then those one or more adjustable configuration settings may need to be edited to accommodate the new peripheral device functional capabilities prior to application of the peripheral device operational configuration policy at the new peripheral device. In such an embodiment, the method may proceed to block 418 for such an editing.

At block 418, in an embodiment in which the new peripheral device workspace is not capable of being configured according to one or more adjustable configuration settings for the user's previously applied peripheral device operational configuration policies for a previously used peripheral device workspace, code instructions for the compliance-adjusted automatic node configuration module may execute to edit one or more of the adjustable configuration settings, if available, for an existing peripheral device operational configuration policy to accommodate the functional capabilities of the new peripheral device within the new peripheral device workspace. For example, in an embodiment described with respect to FIG. 3A, if a given new peripheral device 373 within the new peripheral device workspace 370 is not capable of being configured according to one or more adjustable configuration settings for the user's previously applied peripheral device operational configuration policies for a previously used peripheral device workspace as is, such as 250 in FIG. 2, then those one or more adjustable configuration settings may need to be edited to accommodate the new peripheral device 373 functional capabilities prior to application of the peripheral device operational configuration policy at the new peripheral device 373.

More specifically, as shown in Table 1 at row three, the new peripheral device 373 operating as an external webcam may have a new peripheral device functional capability that includes receiving video signals via a USB 2.0 connection that is not capable of receiving high-definition video, which may be required by the retrieved peripheral device operational configuration, as shown in the middle column. In such a case, the compatibility-adjusted automatic node configuration module 383 may edit the retrieved peripheral device operational configuration policy used to populate the middle column to accommodate the limited peripheral device functional capability listed in the third row of Table 1. In other words, the compatibility-adjusted automatic node configuration module 383 may edit the retrieved peripheral device operational configuration policy such that the requirement for high-definition webcam signal is deleted or moved to a standard-definition webcam signal, as supported by a USB 2.0 connection. This edited peripheral device operational configuration policy may be stored within the peripheral device workspace management system database 385.

In an embodiment at block 420, code instructions for the compliance-adjusted automatic node configuration module may execute to transmit the default, edited, or unedited peripheral device operational configuration policy to the new peripheral device workspace anchor node for institution within the new peripheral device workspace. For example, code instructions for the compliance-adjusted automatic node configuration module 383 may execute to determine that each of the individual peripheral devices, including 373 within the new peripheral device workspace 370 are capable of being configured according to the user's expectations for configuration of the previously used peripheral devices, such as 251 or 254 within the previously used peripheral device workspace 250 of FIG. 2. In such a case, there may be no need to edit the peripheral device operational configuration policy retrieved and used to populate the middle column of Table 1. In other words, the new peripheral device 373 may be configured according to the previously applied peripheral device operational configuration policies without any further edits to those policies. In such a case, the compliance-adjusted automatic node configuration module 383 may instruct transmit the unedited peripheral device operational configuration policy to the workspace configuration recommendation service 382 for transmission by the ecosystem device management service 384 to the anchor node 330 of the new peripheral device workspace 370 in an embodiment.

In other embodiments described above with respect to blocks 414 and 418, the default or edited peripheral device operational configuration policies, respectively, stored within the peripheral device workspace management system database 385 may then generate a recommendation by the workspace configuration recommendation service 382 for transmission by the ecosystem device management service 384 to the anchor information handling system node 330 of the new peripheral device workspace 370. As described in greater detail above with respect to FIG. 1, peripheral device workspace cloud manageability orchestrator module 166 may propagate these peripheral device operational configuration policies to each of the device nodes within the created peripheral device workspace. In such a way, the new peripheral devices within the new peripheral device workspace may be configured to most closely match the users' desired experiences and workload needs, as defined within each user's xID, and to match the configurations of previously used peripheral devices in previously used peripheral device workspaces having similar capabilities to those of the new peripheral device workspace. The method of automatically configuring peripheral devices within a new peripheral device workspace based on configurations of other peripheral devices to which the user's information handling system has been operatively coupled in previously used peripheral device workspaces may then end.

FIG. 5 is a flow diagram illustrating a method of automatically configuring a collaborative peripheral device according to peripheral device operational capabilities that each of a plurality of user information handling systems that are simultaneously operatively coupled to the collaborative peripheral device can accommodate according to an embodiment of the present disclosure. As described herein, in the case where multiple users are simultaneously sharing or are operatively coupled to the same collaboration peripheral device, such as a conference room projector, it may be desirable to configure the collaboration peripheral device in a way that each of the operatively coupled users may interact with it in a similar fashion. Code instructions for the compliance-adjusted automatic node configuration module may execute to identify one configuration or setting for the collaborative peripheral device that each of the collaborating user information handling systems can accommodate. For example, code instructions of the compliance-adjusted automatic node configuration module may execute to identify a screen resolution for a collaborative conference room projector that each of the collaborating user information handling systems are capable of supporting, or for which they may each be configured. The compliance-adjusted automatic node configuration module may then execute code instructions to generate a peripheral device operational configuration policy for the collaboration peripheral device and each of the operatively coupled collaborating user information handling systems within the collaborative peripheral device workspace reflecting the determined configuration or setting for the collaborative peripheral device that each of the collaborating user information handling systems can accommodate. The compliance-adjusted automatic node configuration module may execute code instructions to then transmit that peripheral device operational configuration policy to the ecosystem manageability sub-agent at each of the collaborating user information handling systems and the collaborative peripheral device for application at each of these devices.

At block 502, a peripheral device workspace anchor node user information handling system may collect and transmit to a cloud manageability orchestrator module a peripheral device workspace anchor node status update document including a manifest of peripheral devices in the peripheral device workspace for each peripheral device workspace within an enterprise. For example, in an embodiment described with reference to FIG. 2, each time the peripheral device workspace anchor node information handling system 230 moves to a new peripheral device workspace, such as 260 or 270, a new peripheral device workspace anchor node status update document may be transmitted to the peripheral device workspace cloud orchestrator 280 for association with the peripheral device workspace identification value for the new peripheral device workspace 260 or 270 within storage at the peripheral device workspace management system database 285. More specifically, and as described in an embodiment with reference to FIG. 3B, when the user information handling system 330 moves to the collaborative peripheral device workspace 360, a new peripheral device workspace anchor node status update document may be transmitted by the anchor node for the collaborative peripheral device workspace 360, which may be the user information handling system 330, or another user information handling system 361 or smart peripheral device (not shown). The updated peripheral device workspace anchor node status update document may be transmitted to the ecosystem device management service 384 for storage at the peripheral device workspace management system database 385.

Code instructions for the compliance-adjusted automatic node configuration module may execute at block 504 in an embodiment to determine that the user has joined a collaborative peripheral device workspace in which a plurality of information handling systems operatively couple, simultaneously, to a single, collaborative peripheral device. For example, code instructions for the compliance-adjusted automatic node configuration module 383 may execute in an embodiment to determine that a user for the anchor node information handling system 330 has joined a collaborative peripheral device workspace 360. More specifically, the compliance-adjusted automatic node configuration module 383 may monitor incoming peripheral device workspace anchor node status update documents to determine that a plurality of user composite peripheral device workspace identifiers are associated with a single peripheral device workspace identifier for the collaborative peripheral device workspace 370. This may indicate that the recently joined peripheral device workspace 370 is collaborative, and allows multiple information handling systems 330 and 361 to simultaneously operatively couple with a single collaborative peripheral device 365.

At block 506, code instructions of the compliance-adjusted automatic node configuration module in an embodiment may execute to retrieve a list of peripheral device functional capabilities for the collaborative peripheral device operatively coupled to the plurality of information handling systems. For example, with refence to FIG. 3B, upon determining that the user composite peripheral device workspace identifier has been associated with a collaborative peripheral device workspace 360, the compliance-adjusted automatic node configuration module 383 may retrieve the most recently received peripheral device workspace anchor node status update document for the user composite peripheral device workspace identifier from the peripheral device workspace management system database 385. As described herein, the peripheral device workspace anchor node status update document in embodiments may include a list of peripheral device functional capabilities for each of the peripheral devices including the collaborative peripheral device node, such as 365, listed within the manifest for the collaborative peripheral device workspace 360. For example, the peripheral device workspace anchor node status update document in an embodiment may include a list of peripheral device functional capabilities, such as a video output resolution. More specifically, the peripheral device workspace anchor node status update document may include a peripheral device functional capability for the collaborative peripheral device 365 of 3840×2160 pixel 4K ultra high definition (4K UHD) video output resolution. As another example, the peripheral device workspace anchor node status update document may include a peripheral device functional capability for the collaborative peripheral device 365 of a 60 Hz video output refresh rate.

In an embodiment at block 508, code instructions for the compliance-adjusted automatic node configuration module may execute to retrieve, for each information handling system operatively coupled to the collaborative peripheral device, functional capabilities corresponding to the peripheral device functional capabilities for the collaborative peripheral device. For example, the peripheral device workspace anchor node status update document in an embodiment may also include a list of functional capabilities for each of the information handling systems 361 and 330, listed within the manifest for the collaborative peripheral device workspace 360. For example, the peripheral device workspace anchor node status update document in an embodiment may include a list of information handling system functional capabilities, such as a video output resolution and refresh rate. More specifically, the peripheral device workspace anchor node status update document may include a functional capability for the information handling system 330 of 1920×1080 video output resolution, and a functional capability for the information handling system 361 of 1366×768. As another example, the peripheral device workspace anchor node status update document may include a functional capability for the information handling system 330 of a 60 Hz video output refresh rate and a functional capability for the information handling system 361 of a 60 Hz video output refresh rate.

At block 510, code instructions for the compliance-adjusted automatic node configuration module may execute in an embodiment to determine a minimum functional capability that can be achieved by each of the anchor information handling systems operatively coupled to the collaborative peripheral device in the collaborative peripheral device workspace. For example, code instructions for the compliance-adjusted automatic node configuration module 383 in an embodiment may then execute to determine a minimum functional capability that can be achieved by each of the information handling systems 330 and 361 operatively coupled to the collaborative peripheral device 365 in the collaborative peripheral device workspace 360. More specifically, the compliance-adjusted automatic node configuration module 383 in an embodiment may determine that the information handling system 361 is associated with a minimum or lowest quality video resolution of 1366×768 pixels that can also be accommodated by the information handling system 330 and the collaborative peripheral device 365. As another example, the compliance-adjusted automatic node configuration module 383 in an embodiment may determine that the information handling system 361 and information handling system 330 can accommodate the same refresh rate of 60 Hz as the collaborative peripheral device 365.

Code instructions of the compliance-adjusted automatic node configuration module may execute in an embodiment at block 512 to generate a peripheral device operational configuration policy for the collaborative peripheral device setting each of the list of peripheral device functional capabilities for the collaborative peripheral device to the minimum functional capability achievable by the collaborative peripheral device and each of the operatively coupled information handling systems. For example, code instructions of the compliance-adjusted automatic node configuration module 383 may execute in an embodiment to generate a peripheral device operational configuration policy for the collaborative peripheral device 365 that includes the minimum functional capability achievable by the collaborative peripheral device 365 and each of the operatively coupled information handling systems 330 and 361. More specifically, the compliance-adjusted automatic node configuration module 383 in an embodiment may generate a peripheral device operational configuration policy that includes a setting for a video resolution of 1366×768 pixels that can be accommodated by the information handling systems 330 and 361 and the collaborative peripheral device 365. As another example, the compliance-adjusted automatic node configuration module 383 in an embodiment may generate a peripheral device operational configuration policy that includes a setting for a video refresh rate of 60 Hz that can be accommodated by the information handling systems 330 and 361 and the collaborative peripheral device 365.

The compatibility-adjusted automatic node configuration module 383 may store the generated peripheral device operational configuration policy described directly above within the peripheral device workspace management system database 385. The workspace configuration recommendation service 382 may then retrieve this peripheral device operational configuration policy for transmission by the ecosystem device management service 384 to the anchor node 330 of the new peripheral device workspace 370 in an embodiment. In such a way, execution of code instructions of the compliance-adjusted automatic node configuration module 383 may automatically configure collaborative peripheral devices such as conference room projector 365 for use by all collaborating and operatively coupled user information handling systems 330 and 361. The method of automatically configuring a collaborative peripheral device according to peripheral device operational capabilities that each of a plurality of user information handling systems that are simultaneously operatively coupled to the collaborative peripheral device can accommodate may then end.

The blocks of the flow diagrams of FIGS. 4 and 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A peripheral device workspace cloud orchestrator executing at a cloud-based information handling system comprising:
a network interface device to receive a user experience fingerprint associated with a user composite peripheral device workspace identifier for a user of an anchor information handling system node that has been previously operatively coupled to a previous peripheral device node in a previous manifest for a previous peripheral device workspace at a first identified location;
the network interface device to receive a plurality of stored, adjustable operational configurations of a plurality of previous peripheral device functional capabilities selected by the user for operation of the previous peripheral device node in the previous peripheral device workspace from the user experience fingerprint, and a plurality of new peripheral device functional capabilities for a new peripheral device node that is in a new peripheral device workspace currently operatively coupled to the user anchor information handling system node at a second identified location;
a hardware processor to execute code instructions for the peripheral device workspace cloud orchestrator to determine a user experiential compliance value indicating a similarity between the plurality of new peripheral device functional capabilities and the plurality of stored adjustable operational configurations meet a user experiential compliance value threshold to apply the plurality of stored adjustable operational configurations to the new peripheral device node; and
the hardware processor to instruct the user anchor information handling system node to configure the new peripheral device in the new peripheral device workspace according to at least a portion of the plurality of stored, adjustable operational configurations associated with the user composite peripheral device workspace identifier.

2. The peripheral device workspace cloud orchestrator of claim 1, wherein the new peripheral device node is an external display device and the stored, adjustable operational configuration controls one of display resolution, display refresh rate, brightness, contrast, color gamut, horizontal view angle, vertical view angle, or response time of the new peripheral device node.

3. The peripheral device workspace cloud orchestrator of claim 1, wherein the new peripheral device node is an external webcam and the stored, adjustable operational configuration controls audio/visual connection type, video capture resolution, image depth, video capture refresh rate, or captured frames per second for the new peripheral device node.

4. The peripheral device workspace cloud orchestrator of claim 1, wherein the new peripheral device node is an external microphone and the adjustable operational configuration controls audio output type, audio output frequency, or application of one or more audio filters for the new peripheral device node.

5. The peripheral device workspace cloud orchestrator of claim 1, wherein the new peripheral device node is an external speaker and the adjustable operational configuration controls audio input type, audio input frequency, or application of one or more audio filters for the new peripheral device node.

6. The peripheral device workspace cloud orchestrator of claim 1 further comprising:
the hardware processor to execute code instructions for the peripheral device workspace cloud orchestrator to determine a mismatching one of the plurality of new peripheral device functional capabilities that cannot accommodate a mismatching one of the plurality of stored adjustable operational configurations; and
the hardware processor to instruct the user anchor information handling system node to configure the new peripheral device node according to a default setting for the mismatching one of the plurality of new peripheral device functional capabilities.

7. The peripheral device workspace cloud orchestrator of claim 1 further comprising:
the hardware processor to execute code instructions for the peripheral device workspace cloud orchestrator to determine the user experiential compliance value for each of the plurality of new peripheral device functional capabilities that compares one of the plurality of new peripheral device functional capabilities to one of the stored adjustable operational configurations from the user experience fingerprint; and
the hardware processor to execute code instructions to determine that the user experiential compliance value meets the threshold value based on the one of the stored adjustable operational configurations from the user experience fingerprint.

8. A method of automatically configuring a new peripheral device workspace comprising:
receiving, via a network interface device, a user experience fingerprint associated with a user composite peripheral device workspace identifier for a user of an anchor information handling system node that has been previously operatively coupled to a previous peripheral device in a previous peripheral device workspace at a first identified location;
receiving, via the network interface device, a plurality of stored adjustable operational configurations of a plurality of previous peripheral device functional capabilities selected by the user for operation of the previously used peripheral device in the previous peripheral device workspace;
receiving a plurality of new peripheral device functional capabilities for a new peripheral device node currently operatively coupled to the user anchor information handling system node in a new peripheral device workspace at a second identified location;
determining, via a hardware processor executing code instructions, a user experiential compliance value indicating a similarity between the plurality of new peripheral device functional capabilities and the plurality of stored, adjustable operational configurations from the user experience fingerprint meet a user experiential compliance value threshold such that the plurality of stored, adjustable operational configurations from the user experience fingerprint are to be applied to the new peripheral device node; and
instructing the user information handling system, via the hardware processor, to configure the new peripheral device node according to at least a portion of the plurality of stored, adjustable operational configurations associated with the user composite peripheral device workspace identifier.

9. The method of claim 8, wherein the plurality of new device functional capabilities for the new peripheral device node and identification of the new peripheral device node form a new peripheral device orchestrated device descriptor (ODD) for the new peripheral device node.

10. The method of claim 8, wherein the new peripheral device node is an external webcam and the stored, adjustable operational configuration controls audio/visual connection type, video capture resolution, image depth, video capture refresh rate, or captured frames per second for the new peripheral device node.

11. The method of claim 8, wherein the new peripheral device node is an external microphone and the adjustable operational configuration controls audio output type, audio output frequency, or application of one or more audio filters for the new peripheral device node.

12. The method of claim 8, wherein the stored, adjustable operational configuration defines selection of a communication protocol for a wireless communication link operatively coupling the new peripheral device node to the user's anchor information handling system node.

13. The method of claim 8 further comprising:
determining, via the hardware processor, a mismatching one of the plurality of new peripheral device functional capabilities cannot accommodate a mismatching one of the plurality of stored adjustable operational configurations from the user experience fingerprint; and
instructing the user information handling system, via the hardware processor, to configure the new peripheral device node according to a default configuration of the mismatching one of the plurality of new peripheral device functional capabilities.

14. The method of claim 8 further comprising:
determining, via the hardware processor, the user experiential compliance value for each of the plurality of new peripheral device functional capabilities that compares one of the plurality of new peripheral device functional capabilities to the user experience fingerprint and the stored adjustable operational configuration; and
determining, via the hardware processor, the experience compliance rating meets the threshold value.

15. A peripheral device workspace cloud orchestrator executing at a cloud-based information handling system comprising:
a network interface device to receive a collaborative device functional capability for a collaborative peripheral device node within a manifest of a first plurality of peripheral device nodes at an identified location of a collaborative peripheral device workspace at an identified location that includes a plurality of anchor information handling system nodes of a plurality of users that are each operatively coupled to the collaborative peripheral device node;
a storage memory database to receive and store a user composite peripheral device workspace identifier for each user of each of the plurality of anchor information handling system nodes, wherein each user composite peripheral device workspace identifier includes a stored information handling system functional capability for the associated anchor information handling system node;
a hardware processor to execute code instructions for the peripheral device workspace cloud orchestrator to identify a minimum collaborative workspace functional capability from the collaborative device functional capability that is achievable among the stored information handling system functional capabilities in each user composite peripheral device workspace identifier for each of the plurality of user anchor information handling system nodes; and
the hardware processor to execute code instructions to instruct the anchor information handling system nodes at the collaborative peripheral device workspace to configure the collaborative peripheral device node and each of the plurality of anchor information handling system nodes according to the minimum collaborative workspace function capability.

16. The peripheral device workspace cloud orchestrator of claim 15, wherein the collaborative peripheral device node is an external webcam and the minimum collaborative workspace functional capability describes video capture refresh rate or captured frames per second by each of the plurality of anchor information handling system nodes in the collaborative peripheral device workspace.

17. The peripheral device workspace cloud orchestrator of claim 15, wherein the collaborative peripheral device node is an external display device and the minimum collaborative workspace functional capability describes display resolution achievable by each of the plurality of anchor information handling system nodes in the collaborative peripheral device workspace.

18. The peripheral device workspace cloud orchestrator of claim 15, wherein the collaborative peripheral device node is an external display device and the minimum collaborative workspace functional capability describes color gamut achievable by each of the plurality of anchor information handling system nodes in the collaborative peripheral device workspace.

19. The peripheral device workspace cloud orchestrator of claim 15, wherein the collaborative peripheral device node is an external display device and the minimum collaborative workspace functional capability describes response time achievable by each of the plurality of anchor information handling system nodes in the collaborative peripheral device workspace.

20. The peripheral device workspace cloud orchestrator of claim 15, wherein the collaborative peripheral device functional capability for the collaborative peripheral device node, a unique peripheral device identification value of the collaborative peripheral device node, and a collaborative peripheral device type classification form a collaborative peripheral device ODD for the collaborative peripheral device node stored at the storage memory database for the collaborative peripheral device workspace.
